(19) United States
(12) Patent Application Publication
(10) Pub. No.: US 2017/0300634 A1
(43) Pub. Date: Oct. 19, 2017

(54) SYSTEMS AND METHODS FOR MANAGING ELECTRONIC HEALTHCARE INFORMATION

(71) Applicant: Twin Sails Technology Group, Inc., Houston, TX (US)

(72) Inventors: Jing-Rerng Chiang, Boca Raton, FL (US); Dennis Quan, Cary, NC (US)

(21) Appl. No.: 15/515,595

(22) PCT Filed: Sep. 29, 2015
(86) PCT No.: PCT/US15/53051

§ 371 Date: Mar. 29, 2017

Related U.S. Application Data
(60) Provisional application No. 62/057,229, filed on Sep. 29, 2014.

(51) Int. Cl. G06F 19/00

(52) U.S. Cl. CPC G06F 19/322

(57) ABSTRACT

This invention relates to systems and methods for managing electronic healthcare information on a highly scalable and customizable software and hardware architecture which emphasizes portable devices and minimal downtime during upgrades and scaling. This invention further relates to systems and methods for efficient access and customization of forms for electronically generating and managing patient information. In one aspect of the invention, an electronic health record system (EHR) of the present invention, which may also be referred to as an electronic medical record system (EMR), may be deployed and run on a plurality of servers over which the computing and/or storage load may be distributed in a non-centralized manner such that the overall system may remain up and operating even while being scaled, upgraded and/or otherwise modified.

### FIELD OF THE INVENTION

This invention relates to systems and methods for managing electronic healthcare information, particularly to systems and methods for highly scalable and customizable creation and management of electronic healthcare information.

### BACKGROUND OF THE INVENTION

Medical professionals keep records on patients. Such records are generated when a patient sees a medical professional, for example, is first admitted or registered, during the stay in the hospital and upon discharge from the hospital. The admission or registration process typically includes the filling out of forms by a patient or intake personnel, and the captured information used to be handwritten or typed. More recently, hospitals have included inputting such intake information on a form displayed on the computer screen. This form is generally pre-filled with headings for general information such as patient's name, date of birth, etc. followed by spaces for inputting such information. If the space is not sufficient for inputting the information, it is generally recommended that a separate page be used and to attach the additional page to the record. In the end, some hospitals still keep such records in paper form. In addition to collecting general information, many hospitals also collect specific types of information that may relate to that hospital's specialty areas or to specific best practices put in place by the hospital personnel. Such information also gets collected from patients using specialized forms.

When records are generated on a computer, they can also be stored electronically on a server, in the same format manner as paper forms are stored. As with paper forms, the more information that is created, the more records need to be stored. When a server is overloaded, a larger and more powerful server has to be installed to take care of the increased load, similar to relocating files to a larger storage space or building, which generally involves down time for upgrading and installation. Down time also means information is inaccessible.

### SUMMARY OF THE INVENTION

This invention relates to systems and methods for managing, for example, electronic information (or electronic record management or ERM) in various industries having a need for on demand information gathering including, but not limited to, healthcare, customer relationship management, human resources, accounting, project management, political/charity campaign management, and similar, on a highly scalable and customizable software and hardware architecture operable on, for example, devices including stationary or desktop devices, mobile devices, portable devices or combinations thereof, and minimal downtime during upgrades and scaling. This invention further relates to systems and methods for efficient access and customization of forms for electronically recording and managing, for example, patient information.

In one embodiment, this invention relates to systems and methods for managing electronic healthcare information in the healthcare industry, on a highly scalable and customizable software and hardware architecture operable on, for example, devices including stationary or desktop devices, mobile devices, portable devices or combinations thereof, and minimal downtime during upgrades and scaling. This invention further relates to systems and methods for efficient access and customization of forms for electronically recording and managing, for example, patient information.

The present invention leverages the flexibility of, for example, hierarchically-structured data (HSD) documents such as JSON documents and a unique manner in which HSD documents such as JSON documents may be dynamically processed on any appropriate device mentioned above. For example, in the healthcare area, the present invention allows complete electronic health record systems to be created based on a set of specifications encoded in, for example, hierarchically structured data (HSD) documents (known as “system objects”) stored on at least one computer server. Users in the healthcare area may include physicians, nurses, radiology technicians, pharmacists, billing specialists, hospital administrators, and even patients themselves. They may interact with the electronic health record system via a device, for example, a portable or mobile device, which retrieves contextually--relevant system objects from at least one computer server and follows a set of specific processes defined herein to realize a user interface for querying, viewing, interacting with, and editing, for example, HSD documents containing healthcare-related data (known as “health record documents”) stored on at least one computer server. “Health record documents” as used herein are broadly defined to include clinical and non-clinical, patient-specific and non-patient specific data that may be used by healthcare professionals to provide care for patients. Examples of providing care for patients may include, but not limited to, surgery procedure orders (clinical), insurance billing information (non-clinical), pharmacy inventory (non-patient-specific), and messages sent between physicians and nurses (patient-specific). The user interface that may be created on the fly may support simple operations such as listing/viewing health record documents such as allergies lists and medication lists or statistics across multiple health record documents such as a daily emergency room admission rate as well as more complex, multi-step operations such as allowing a physician to write and sign a prescription order to be dispensed by a pharmacist and administered by a nurse. The device, for example, a mobile device may also, based on what is specified in the system objects, restrict visibility to specific user interface elements based on the class of user currently logged into the system, so that, for example, radiology technicians are presented with a list of x-ray orders to be performed and do not see billing information, or pharmacists are restricted from seeing messages sent by patients to their physicians. In general, because customizations affect only the system object definitions and not the software code running on the mobile device or the computer server, customizations to the electronic health record system may be rolled out, updated, and maintained at any time with minimal system downtime and without needing new versions of the mobile device software or the computer server software.

In one aspect of the invention, an electronic health record system (EHR) of the present invention, which may also be referred to as an electronic medical record system (EMR), may be deployed and run on a plurality of servers over which the computing and/or storage load may be distributed in a non-centralized manner such that the overall system may remain up and operating even while being scaled, upgraded and/or otherwise modified.

In some exemplary embodiments, an EHR system of the present invention may be a software system that may generally include a plurality of essentially identically configured worker nodes that are deployed and run on a plurality of servers in a server pool. In the present invention, the EHR system may distribute its workload and/or storage load across the servers in the server pool, such as, for example, substantially evenly across the available servers in the server pool. Since the EHR system may include a plurality of essentially identically configured worker nodes, individual worker nodes may be taken down, fail, and/or be modified without affecting the other worker nodes and/or significantly impacting the overall operability of the EHR system. This may be desirable as the EHR system may generally be used to run the operations of any healthcare facility and in such medical settings where the need to access patient information is, for example, often time-sensitive and essential for proper patient treatment. Thus, experiencing minimal or no downtime of the EHR system once deployed may insure smooth operations without unnecessary interruptions. In this manner, for example, the server pool may have additional servers added in and/or servers taken down, whether for replacement, upgrade, repair or otherwise, at almost any given time to modify the capacity and/or functionality of the server pool without the EHR system experiencing downtime due to server modifications, thus minimally impacting the availability of the overall system

In some embodiments, the EHR system of the present invention may be built on a highly-automated installation platform where individual components of the system may be packaged into separate images, which may include the configurations of the specific components. The system may create and run instances of the components from the images while keeping any data generated meant to be persistent stored separately from the image in persistent storage. Thus, the system may create and dispose of instances of the components at will without loss of either configuration information, which is stored in the image, or persistent data, which is stored in persistent storage. The separate EHR system components may then be taken down for upgrades, repairs and/or other modifications without affecting other components.

In one embodiment, the EHR system of the present invention may be built on an automated installation platform, for example, “Docker”. “Docker” may generally leverage Linux Containers, a technology built into Linux that is lighter weight than traditional virtualization methods. The components of the EHR system of the present invention may then be packaged into “Docker” images. Images may then be started within “Docker” to produce running instances of the components. In a traditional environment, for example, these instances may be akin to an installed piece of software running on a stack of middleware and other components for which significant time and energy are invested in configuration. In contrast, instances of the EHR components in this embodiment may generally be easy to create and may be disposable when, for example, repairs, upgrades and/or modifications to the EHR system are desired or necessary. “Docker” may also generally allow for separation of configuration data for each component, which may be stored in the “Docker” image, and persistent data, which may be stored in persistent storage. The instances of each component may thus be disposed of at any time because the configuration of the instance may be recreated at any time by, for example, launching a new instance based on the same original image, while the persistent data managed by the instance is not stored in the instance itself but in a persistent storage, such as a backend, for example, a network attached storage (NAS).

In some embodiments, persistent data may be stored using a scalable backend database system which may generally utilize non-relational database structures, but may rather utilize a discrete document-centric structure which may further leverage scalability, document replication and/or load distribution on a server or storage pool. The database system may also, for further example, utilize a document locking system where documents remain viewable to all allowed users, but only one user may modify the document at a time by checking it out of the database. This may be desirable to prevent, for example, concurrent modification of documents which may introduce conflicting information. This is especially desirable in the healthcare area, where conflicting information may have life and death consequences.

In one exemplary embodiment, the scalable backend database system may employ a NoSQL database such as, for example, “MongoDB”.

In another aspect of the invention, the EHR system may be designed to be primarily accessed, maintained and utilized almost entirely from portable or mobile devices with only certain functions requiring direct access to a server and/or a stationary computer. This is unlike most EHR systems in general, which are designed for use with stationary computers with any mobile access or functionality being an afterthought. This in general reflects a more traditional or dated approach to maintaining health records which are more akin to paper and file room systems that do not significantly leverage any technological advances that allow for a different approach to managing information.

In general, accountability and auditability are important concepts in the medical field. As accurate patient records are relied heavily upon to make informed clinical decisions, the EHR system of the present invention may be designed to track all changes that occur to patient records by, for example, date, time, user and/or any other appropriate manner. The EHR system may also generally store all and/or a desired selection of past versions of documents in the database to facilitate audits. Users of the EHR system may also facilitate auditability through the use of the check-in (unlock) and check-out (lock) actions available in the EHR system, as these actions may generally, for example, also prevent multiple users from making potentially conflicting modifications to any given document.

In some embodiments, all primary users of the EHR system of the present invention may utilize a portable or mobile device for their access and utilization of the EHR system. In one embodiment, iPad®, Android®, Windows® tablets and/or other similar tablet computing devices may generally be utilized. In general, it may be desirable for the EHR system of the present invention to be utilized from a popular, widespread and/or familiar computing platform, as this may allow, for example, users to concentrate on their actual tasks rather than trying to figure out an unfamiliar and/or overly complex software interface. In addition, popular and/or widespread computing platforms may generally benefit from diligent technical support, issue familiarity, updates and/or availability of replacements. The EHR system of the present invention may generally be utilized on any appropriate device, which may include, but is not limited to, a smartphone, a tablet computer, a personal computer, and/or any other appropriate computing device. In general, the EHR system of the present invention may employ a graphical user interface (GUI) and depending on the device, it may be accessible with a touchscreen interface and/or a keyboard/mouse interface, whichever may be appropriate. The EHR system of the present invention may also employ other forms of interface, such as those designed for use with visually and/or hearing impaired users, and/or alternative interfaces, which may include, for example, voice recognition and/or playback, Braille computer interfaces, haptic interfaces, and/or any other appropriate interface.

In a further aspect of the invention, the EHR system of the present invention may utilize a highly customizable architecture that may generally enable the EHR system to be customized to fit any particular needs of the user(s) without any drastic changes to the underlying functionality and/or design of the EHR system. In some exemplary embodiments, the EHR system architecture of the present invention may be based on having the configuration of most aspects of the system exposed to administrators in the form of system objects, where, for example, changes including, but no limited to, adding a field to a form to creating a new workflow for handling lab orders are all achievable without changes to the underlying EHR system of the present invention. System objects may generally be defined using the YAML syntax and may exist as, for example, hierarchically-structured data (HSD) documents of which JavaScript Object Notation (JSON) documents is an example, in a similar fashion to all other documents (such as patient records) managed by the EHR system.

In yet another aspect of the present invention, the EHR system of the present invention may be efficiently and easily customized for installation at a working site, such as, for example, a hospital, doctor's office, and/or other healthcare institution, without a great deal of “back end” customization of the EHR system in order to achieve a working implementation. In general, one of the biggest expenses in bringing an EHR online for a group of medical professionals is the time spent implementing an institution's existing workflows and processes within the system. Although most institutions share the same basic concepts of encounter, patient account, order, laboratory result, protocol, and/or others, the exact way these concepts are stitched together to drive patient care from admission to discharge can differ significantly from one institution to another. In many situations, a gradual process is used during a typical EHR implementation to identify and discern the interconnections amongst the different pieces of an institution's workflows and processes. Effective EHR systems are generally designed to accommodate small, incremental, potentially frequent changes to the system configuration in order to properly implement the EHR system so that it will work with the institution. Often, the definitions of forms, workflows, and other aspects of the system are sometimes hard-coded into the EHR itself, which often requires the allocation of highly-skilled developers' time to implement due to the required changes being done on the “back end”. Further in general, once institutional customizations start to entail changes in the underlying EHR product, the notion of frequent incremental changes can become impractical.

In one exemplary embodiment of the invention, the present invention relates to a method of defining custom forms in an electronic health record system without creating multiple versions of the electronic health record system software. A solution to the above challenge as well as allowing multiple institutions to have different customizations to their electronic health record system without creating multiple versions of the mobile device and/or server software are achieved by the present invention. This is accomplished by leveraging the flexibility of documents storing data with a standardized syntax or format, such as for example, HSD documents such as JSON documents, and a unique manner in which such documents, such as JSON documents, are dynamically processed on any appropriate device mentioned above, whether mobile or not. For example, health records may be stored as a series of HSD documents such as JSON documents on at least one computer server. This may allow software installation or servicing technicians, not higher-skilled software developers, to define form layouts (e.g., demographics form, allergies form, etc.) as a series of HSD documents such as JSON documents stored on at least one computer server without the complexity or technical sophistication of changes to the underlying software. The form layouts (as defined by the above mentioned technician) may specify a series of form-level widgets, including “sections”, “lists”, “notes” and “section divider tabs” or others. The sections may further specify a series of section-level widgets, including text fields, code pickers, date/time pickers, signature fields, single/multiple choice pickers, yes/no buttons, calendars, checkboxes, custom HTML widgets, directory user/group pickers, weight/length/height/blood pressure fields, barcode fields, photo fields, number scale pickers, room pickers, document pickers, etc.

Unlike a paper document, the mobile device software performs specific processing to combine the health record HSD documents such as JSON document and the form layout HSD documents or JSON document (both retrieved from at least one of the computer servers) to result in the final presentation that allows the user to read and/or change data in the electronic health record: the mobile device software lays out the form-level widgets vertically on the screen and fill in the widgets with the information from the health record HSD documents such as JSON document so that a user can easily use a tactile, keyboard-driven, or voice-driven paradigm to interact with the data via a, for example, mobile device screen.

Form layouts may specify property “mappings” that tell the, for example, mobile device software which widgets may be used to manipulate which parts of the health record HSD document such as JSON document. A property mapping may define a sequence of hierarchical operations (e.g., retrieving/modifying elements of arrays at specific indices, retrieving/modifying values of key-value pair tables based on specific keys) for retrieving and/or recording data inside a HSD document such as JSON document to be displayed and/or collected from the user by the widgets on the device screen.

Form layouts may also specify automatic title/subtitle generator algorithms written in, for example, JavaScript to allow a title and/or subtitle to be computed based on properties of the health record HSD document such as JSON document. In this way, the way health record documents are named may be customized without modifying the for example, mobile device and/or server software. The device such as mobile device software may simply need to execute the, for example, JavaScript title/subtitle generator whenever the health record document is modified in the, for example, mobile device software.

Also for example, list widgets may be rendered by the, for example, mobile device software as a table with rows and columns. The rows may correspond to entries in an array of the health record HSD document such as JSON document, and the columns may include specifications of section-level widgets to be displayed in the cells of the row corresponding to a given entry of an array in the health record HSD document such as JSON document. The list widget definition can also specify an embedded form layout to show some or all of the remaining data for a given row's HSD object that appears when the user taps on an “info” button rendered at the end of the row; this is useful in cases where there isn't enough space to display all of a row's information using the column-based mechanism.

For code picker widgets, a further processing step may be performed, such as: at least one of the computer servers may be used to store a set of “codes” that represent standardized treatment concepts e.g., radiology procedures such as a mammogram, anatomical elements such as the left arm, lab procedures such as a cholesterol test, possible demographic attributes such as Asian race or Christian religion, etc.). A code picker widget specification may define a restricted subset of possible codes that may be displayed to the user and accepted as possible values from the user (e.g., only religions; only radiology procedures; only non-branded drugs; etc.). The mobile software queries at least one of the computer servers for codes that may match the restrictions specified and presents them on the visual form seen by the user on the mobile device to be “picked” from.

The mobile device software may allow the user to automatically fill in a health record document form using values from a health record document that has a related purpose or a similar layout. This may be useful in scenarios where information such as demographics are being updated on a second visit to a doctor, thus saving the doctor or other user from needing to re-input data that might not have changed from the previous visit. The mobile device software, for example, may display a menu on the mobile device screen that enables the user to pick another health record document to “auto fill” from. The mobile device software, for example, may auto-fill the widgets with values from the other document and highlights these widgets in yellow. the form layout may be configured to specify that this auto fill process occurs automatically whenever a suitable document already exists on at least one of the computer server to auto fill from.

A variation or alternative on this may be “reconciliation”, which works on primarily list-based forms (the form layout specifies the nature of the list on the form to be reconciled and the characteristics of the documents that the reconciliation process can work against). When a user is working on a specific form, the mobile device software, for example, may present a menu to the user to select related documents. The mobile device software retrieves the document(s) chosen by the user from at least one of the computer server and merges the “rows” from the different related documents together onto the form, displaying rows from the other documents in yellow. The user may then be allowed to accept or remove the rows in yellow. At the end of reconciliation, the mobile device software merges the rows that remain together into a single document and saves the document on at least one of the computer server. An example of this may be as follows: a surgeon is preparing to operate on a patient referred to him/her by the patient's primary care physician. The surgeon is filling out a form with the medications the patient is currently taking. The form is not technically redundant, because the surgeon wants to personally make doubly sure of the medications the patient is taking before operating on him/her. Separate from the form the surgeon is filling out is a form that came from the patient's primary care physician that also lists the medications the patient is currently taking, at least as was recorded by the primary care physician at the time the form was filled out. In this scenario, the, for example, mobile device presents the surgeon with a menu of other medication lists stored on at least one of the computer server to reconcile with, and one such medication list is the one from the primary care physician. After the surgeon selects the primary care physician's medication list from the menu, the mobile device creates a merged list of medications from the list the surgeon was filling out and the list the primary care physician provided. the list is presented so that the rows containing medications merged in from the primary care physician's list are highlighted in yellow, and the surgeon is then prompted to either keep or remove those yellow highlighted rows, as an indication of either acknowledging or rejecting medications that the primary care physician indicated were being taken by the patient at the time the primary care physician's form was filled in. After the surgeon has taken action on all the yellow highlighted rows, the mobile device then saves the final document to the computer server.

The computer server may store all possible codes (there could be hundreds of thousands of these codes) using a search engine database stored in persistent storage. When a user looks for a specific code based on certain criteria (e.g., text search term, type of code such as radiology procedure, etc.), the computer server iterates through the storage to find codes that match the criteria specified, possibly using an index or a distributed search (whereby the codes are distributed across multiple computer servers that serve to divide-and-conquer the search) to optimize this process.

The computer server stores HSD documents such as JSON documents in a way that differs from standard paper forms in two ways. First, an audit trail is created that automatically records not just changes (what, and by whom) to each HSD form, such as JSON form, but also records when contents are viewed, queried, or printed (what, and by whom). Second, HSD documents such as JSON documents may be “locked” by a single user to prevent concurrent changes to the same document by other users.

The audit trail exists in a different part of the storage on at least one of the computer servers and is modified every time a change, view, print, or query activity is performed.

The locks may also be stored in a different part of the storage on at least one of the computer servers. One lock may be automatically created per HSD document such as JSON document and has the following properties: (a) ID of underlying JSON document; (b) user ID of person who has locked the JSON document (if the document is currently locked); (c) security token of the login session of the user in which the user has locked the document; (d) timestamp of when the lock was established.

When a user wants to modify a HSD document such as a JSON document on the device, such as a mobile device, the mobile device software first confirms that no other user has placed a lock on the document on at least one of the computer servers.

In general, form layouts may be updated independent of the health record JSON documents and independent of the version of the for example, mobile device and/or server software, as long as the capabilities (as opposed to the specific customizations themselves) relied upon by the form layout definitions are supported by the version of the mobile device and/or server software.

Fragments of health record form HSD documents such as JSON documents may also be stored on at least computer server to support scenarios where a user has information that is routinely entered into a health record form; the mobile device software's auto-fill menu above may also display applicable health record form fragments, and, when a user taps on a menu item corresponding to such a fragment, the mobile device software can auto-fill the form with those fields that were stored in the fragment.

To facilitate the process of creating multiple health record form documents at once, the mobile device software, for example, may allow specially-marked list widgets to collect information for multiple documents using “batch mode”. For example, to allow a user to enter multiple medication orders at once, a specially-marked list widget may be specified, where each row in the table is actually a separate medication order. After the user has completed inputting all the information for the batch document creation, the mobile device software, for example, creates a separate copy of the health record document just created, except that the property linked to the specially-marked list widget in each separate health record document copy created contains a single row of the original array instead of the entire array.

Some medical forms may require images, scanned documents, or other graphical elements. At least one computer server may store a graphical attachment that may be associated with each health record form. The form layout may specify an area of the screen to display the graphical attachment.

In another exemplary embodiment of the invention, the present invention includes a method of defining custom workflows in an electronic health record system without creating multiple versions of the electronic health record system software. The challenge here is how to customize an electronic health record system to allow specific classes of users to create, review, approve, or reject health record forms in a sequence of steps that corresponds to the processes that exist in a hospital or other healthcare institution (e.g., registering a new patient, allowing a pharmacist to review prescriptions written up by a nurse on behalf of a doctor, recording that a medication dose was given to a patient, etc.) without requiring multiple versions of the mobile device/server software. The present invention accomplishes this by leveraging the flexibility of HSD documents such as JSON documents and a unique manner in which HSD documents such as JSON documents are dynamically processed on any appropriate device mentioned above, for example, to provide a solution that may allow technicians to define “modal processes” as HSD documents such as JSON documents stored on at least one computer server. The modal processes are defined using script code such as JavaScript code (of course this could be generalized to use some other programming language). The code may run on the, for example, mobile device and may dynamically interact with at least one computer server performing operations such as queries, creation of documents, locking/unlocking of documents, as defined above, and deleting of documents. The modal process code is given access to the “context” of the operation (e.g., if the code is invoked while the user is looking at a specific patient record, the modal process is passed a parameter notifying it of the patient's ID). The modal process code may also be allowed to display forms on the screen using a “stack” metaphor. The forms may be similar to the health record forms described above that are created by a technician, except the forms in a modal process may be dynamically generated on the fly based on the context, information gathered from other health record documents, etc. These forms may display/capture data that is specific to the human process being implemented. The stack metaphor is similar to a web browser's metaphor in that when a new form is displayed, it has the option of being “stacked” on top of the previously displayed form so that the user may tap on a “back” button and go back to the prior form.

The invention also may allow technicians to define workflow approval steps as part of the form layout HSD documents such as JSON documents (described as part of #1 above). A workflow may be defined as a series of digital signatures that need to be collected from a defined set of user classes (the workflow's “steps”) in order to reach a final “state” (e.g., an “approved” state). The mobile device software, when displaying a health record form to the user, may show buttons on the screen to allow users to “submit”, “approve”, “reject”, or “confirm” these actions (with the exception of “reject”) may result in a digital signature (using a standard digital signature algorithm such as SHA-256) being computed for the data displayed on the form based on the current user's private key and being added to the health record document saved on at least one computer server. Furthermore, as necessary digital signatures are collected and further digital signatures become needed as the document passes through steps in the workflow, at least one of the computer servers may be used to store a pointer to for example, the doctor in a portion of the server's storage dedicated to either a specific user or to a specific class of users called a “queue”. The mobile device software, for example, may present the queues that correspond to the logged-in user or the classes of users that user belongs to in order to remind the user that documents are waiting for him/her to sign. “Reject” works somewhat differently for example, the mobile device software removes the digital signatures collected up to that point and returns the document to the queue of the original submitter (the first signer). “Confirm” is an action that is supported to allow a user acting as a proxy for the actual authorized user or actual authorized class of users for a particular step to sign a document as a proxy. A pointer to the document may then be stored in the queue for the authorized user or class of users on whose behalf the proxy user is signing, providing the authorized user an opportunity to “confirm” that the proxy did indeed act on their behalf.

In a further exemplary embodiment of the invention, a method of defining custom views in an electronic health record system without creating multiple versions of the electronic health record system software is included. The challenge of how to customize an electronic health record system to allow users to use the, for example, mobile device software to see information that may be derived from multiple health record forms and collated/rearranged/corresponded/cross-referenced to make it easier to support decision making processes, without changing the way the health record forms are stored on at least one computer server (e.g., show a list of upcoming medication orders to fill for all admitted patients, show a specific patient's blood pressure and heart rate for the last 2 hours as a graph, etc.) is solved by leveraging the flexibility of HSD documents such as JSON documents and a unique manner in which HSD documents such as JSON documents are dynamically processed on any appropriate device mentioned above. For example, health records may he stored as a series of HSD documents such as JSON documents on at least one computer server. The solution of the present invention includes allowing technicians to define “custom widgets” as HSD documents such as JSON documents stored on at least one computer server. The custom widgets may be defined using a mix of HTML and script such as JavaScript, for example (of course other languages could be chosen as well), stored inside a HSD document such as JSON document. The code may run on the device, for example, the mobile device, and may dynamically interact with at least one of the computer servers performing operations such as queries, creation of documents, locking/unlocking of documents, as noted above, and deleting of documents, as also noted above. The custom widget code may be given access to the “context” of the display request (e.g., if the code is used to display information while the user is looking at a specific patient record, the custom widget is passed a parameter notifying it of the patient's ID). Since standard web technologies may be used to host the custom widget on the device such as a mobile device, third party libraries (e.g. for displaying charts, computing body-mass index, etc.) may be easily incorporated. In addition, the present invention may allow multi-portlet “reports” to be defined as HSD documents such as JSON documents stored on at least one computer server. The reports specify a set of widgets (including the custom widgets described above but also including modal processes) to be displayed simultaneously by the mobile device software in order to provide specific classes of users with visibility into related information on a single screen. The HSD document such as JSON document that defines a report provides a list of widgets to be displayed, as well as geometric constraints such as width/height to allow the mobile device software to lay the widgets on the screen in a visually-appealing way.

In yet another exemplary embodiment of the present invention, a method of defining custom navigation menus in an electronic health record system without creating multiple versions of the electronic health record system software. The challenge of how to customize the user interface menus shown to one or more classes of users so that relevant information is easily accessed, in light of the fact that (a) any given user could be a member of not just one but multiple classes at once; (b) the information that is deemed relevant to a class of users may change quickly due to the development of new treatment protocols, some of which in extreme cases may not be able to wait for a new version of the mobile device/server software is solved by leveraging the flexibility of HSD documents such as JSON documents and a unique manner in which JSON documents are dynamically processed on any appropriate device mentioned above. For example, health records may be stored as a series of HSD documents such as JSON documents on at least one computer server. The solution presented by the present invention allows technicians to define “table of contents levels” and “table of contents level contributions” as HSD documents such as JSON documents stored on at least one computer server. When a patient record is displayed by the mobile device software, for example, the mobile device software queries at least one of the computer servers for table of contents levels and table of contents level contributions that correspond to the object in context (which is usually, initially, the health record form containing the patient's basic/demographic information). The table of contents level HSD document such as JSON document may be identified by a unique identifier (as are all HSD documents such as JSON documents stored on at least one computer server) and may contain information such as how to compute the title to be shown for the menu corresponding to this level and how to query at least one of the computer servers for information and/or health record documents that are appropriate to be displayed at this menu level. The table of contents level contribution HSD document such as JSON document may list the classes of users that the contribution is relevant to and contains a reference to the unique identifier for the table of contents level HSD document such as JSON document it is “contributing” to. When a menu is displayed in the device, for example, mobile device software, the table of contents level contributions that are relevant to the logged in user (due to the user's membership in certain user classes such as physicians, nurses, lab technicians, etc.) are aggregated and displayed as a menu. Each table of contents level contribution may include a series of sections; each section includes a sequence of menu item specifications. Sections may be displayed in sequence vertically, one after another, and within each section, menu items may be displayed in sequence vertically, one after another, according to the menu item specifications. There are several types of menu item specifications, including: (a) references to form layout HSD documents such as JSON documents—which indicates that health record documents that are part of the result set of the query to at least one of the computer servers as specified in the table of contents level JSON document and that were created using the referenced form layout HSD document such as JSON document should have an associated button displayed at this part of the menu which, when tapped on, causes the document to be opened for editing; or alternatively, a button can be shown to allow a user to create a health record document using the referenced form layout; (b) references to custom widgets, multi-portlet reports, or modal processes, in order to allow users to tap on the resulting menu item to bring up the corresponding user interface element in the context of the menu; (c) references to built-in commands, such as “print” or “add patient portal guest account”, to provide the user with access to function built into the mobile device software; (d) health record form fragments, which prompt the mobile device software to display a menu item that allows the user to create a new health record form based on the pre-filled values from the fragment. Table of contents level contributions' sections may also be prioritized with a number (sections with a lower priority number are sorted to be displayed earlier in the menu) and also assigned an override key—this allows multiple contributions that define sections with the same override key to only have the one section with the highest (or lowest) priority displayed instead of all such sections. Finally, the mobile device software can display submenus (i.e., a subordinate set of table of contents level-table of contents level contributions) when menu items that correspond to specific document types or documents are tapped on, rather than opening the document up for editing.

In still yet a further exemplary embodiment of the present invention, a method of rolling out customizations (forms, workflows, custom views, navigation menus) to the production system via a series of test environments. The challenge of how to validate customizations on alternate computer servers that mimic the one in use by institution staff in various ways, and eventually deploying updated customizations to at least one of the production computer server with minimal interruption is solved by leveraging the flexibility of JSON documents and a unique manner in which HSD documents such as JSON documents are dynamically processed on any appropriate device mentioned above. For example, health records may be stored as a series of HSD documents such as JSON documents on at least one computer server. The solution assumes an environment with multiple computer servers configured for test use (e.g., one with test patient records used for simple testing, one with a copy of real patient records used for compatibility testing, one for training purposes with fake patient records created by the staff, etc.) in addition to at least one of the production computer server. The mobile device software supports propagation of customizations via a “sync” process, that is, the user uses the mobile device software to log into two computer servers at the same time, and customization (i.e., as opposed to health record) HSD documents such as JSON documents on both servers are compared. The comparison process may be performed on the device, such as mobile device and works as follows: (a) HSD documents such as JSON documents are labeled with unique identifiers (e.g., 128-bit UUIDs) that allow identification of which HSD documents such as JSON documents on both servers are considered to be different versions of the same document; (b) a hash (e.g., MD5 or SHA1) is computed of the canonicalized version of the HSD documents such as JSON documents and compared; if they are the same, then the document is assumed to have not changed; (c) if there is a difference, last-updated or last-synced timestamps on the two documents are compared, and if there is a difference, the mobile device software indicates to the user which of the two is considered more up to date; (d) for HSD documents such as JSON documents that exist on only one server or the other (i.e., do not have a document on the other server with the same unique identifier), the mobile device software indicated to the user that the document is new; (e) the mobile device software allows the user to select which versions of the documents to keep and which versions to propagate in either direction, and can simplify this process by automatically suggesting that documents that are only on one server and not the other or where one server has a document that was modified based on the version present on the other (i.e., it is not the case that a pair of documents on either server were modified simultaneously) can be safely propagated; (f) the mobile device software then performs the propagation on each selected document by either directly adding the document to the other server (if the document is new) or first locking the document on the target server, writing the new version to the target server, and finally unlocking the document (similar to locking/unlocking concepts described earlier).

Unlike software changes that usually require a system to be taken offline or shutdown for a period of time to replace the software binaries, the customizations in the present invention are stored as configuration data and not manifested in binary code, no change to the mobile device/server software is required, thus, reducing downtime. Also, unlike a human process of synchronization, which is error-prone especially since HSD such as JSON is very information-dense and changes are hard to pick out visually, the automated process performed by the mobile device software is able to compare large numbers of customizations very precisely and accurately using hashing. Also, as HSD documents such as JSON documents are always “available” to be retrieved by other users using mobile devices, even while new versions are being written to a given computer server (employing a basic property of databases called atomicity), and also because customization HSD documents such as JSON documents may be made to be “backward- and forward-compatible” by only allowing compatible widget changes (e.g., replacing a checkbox with a yes/no choice), by doing additions of new widgets (thus not affecting the ability to read/edit values displayed by pre-existing widgets), or by adding completely new health record form templates, downtime is not required to perform these updates to any computer server, including the production computer server; this is in contrast to many traditional relational database-based (or even binary code-based) customization models, where a schema change to support new customizations can possibly require downtime of the computer server and hence the overall electronic health record system.

In still yet another exemplary embodiment of the present invention, the present invention includes a method of entering health record data in a multi-modal fashion. Since navigating a large number of menus and forms on a, for example, mobile device to find where certain information has been/should be recorded may be difficult, especially for doctors who are used to paper records, a need to support users with various usage patterns/requirements, even within a single institution, without requiring custom versions of the mobile device/server software can be a big challenge and is achieved by the present invention by leveraging the flexibility of HSD documents such as JSON documents and a unique manner in which HSD documents such as JSON documents are dynamically processed on any appropriate device mentioned above.

The user may supply the parameters to a given action (e.g., write a discharge note, order a drug, etc.) through a combination of multiple modalities (e.g., voice, touch, typing, etc.) and the installation technician may specify possible commands in the form of HSD documents such as JSON documents stored on at least one computer server. For example, the technician may define a set of commands, each command definition may include the following parts: (a) the set of user classes that are allowed to use the command; (b) utterances that invoke the command, which may include variations in language (e.g., “show me allergies” versus “display allergies”) and may use natural language processing techniques for describing possible variations (e.g., BNF grammars); (c) a set of parameters, each of which may include (i) a name, (ii) a semantic type (e.g., date patient ID, etc.), (iii) a flag indicating whether it is optional, (iv) a flag indicating whether the object represented by the parameter needs to be “open for editing” (e.g., in order to execute the command “take this down as the patient's symptoms”, the “symptoms” health record document needs to actually be open on the, for example, mobile device and not just identified); (d) code to execute whenever parameters are collected by the for example, mobile device due to user actions, which executes the command when all needed parameters have been collected; (e) optionally, messages that may be outputted to the user to confirm and/or disambiguate (e.g., for the operation “show how much weight was gained between two visits”, after one of the visits has been specified, there may be a need to prompt the user to “specify which visit to compare against” because generic language such as “specify visit #2” may not be user friendly). The device, for example, mobile device, software, on user login or on startup of the speech recognition session, may load all HSD documents such as JSON documents with speech command specifications from at least one computer server that apply to the user classes to which the user belongs. When a natural language command is captured by the, for example, mobile device software (using a speech recognition component/technology that might be provided by the platform, by a voice recognition library, or by some other natural language input mechanism, including the keyboard), it is compared against possible command utterances to find a command that matches. If a match is found, a “session” is started to collect parameters through a repetitive process of (a) looking at parameters that might be satisfied by the current context of the user (e.g., a patient record that was just opened on the mobile device by the user's touch actions may qualify as a patient parameter to the command being executed); (b) prompting the user to locate or identify objects that satisfy the needs of a given parameter (e.g., “you want to display a patient's allergies. please identify a patient”), possibly via a verbal message or through something displayed on the device; (c) invoking the code inside the command definition to account for new objects either collected from the user or identified from context as possible parameter values and, if all parameters are satisfied, executing the command—the script such as JavaScript (or other language) code would then interact with the mobile device/server software to add/query/remove health record documents, display them on the screen, or other actions appropriate to the command.

One possible action that may occur after a command's parameters have been satisfied and a command is ready to be executed (as specified by the code inside the command definition) is to change the operating mode of the for example, mobile device into dictation mode. In this mode, outside of fixed utterances that either operate on the text being collected via dictation (e.g., copy/paste, delete) and utterances that indicate the end of dictation mode, the speech captured is collected as a value for some field specified by the command definition (e.g., “special instructions for prescription dispensation”), This may prevent utterances such as “prescribe acetaminophen twice a day” from being confused as a command for the system when the intent is for it to be captured as text and recorded directly into a health record document.

Another possible action that may occur (perhaps multiple times) during the capture of parameters and at the end of parameter capture (as specified by the code inside the command definition) is voice cueing. Verbal messages being spoken to the user at certain points in the dialog may help guide the user to provide the necessary parameters for executing the command.

For example, one built-in command may be “never mind” or its variants, which when heard by the, for example, mobile device software indicates that the user wants to cancel executing the command and capturing any needed parameters.

Multiple commands may be “nested” in various ways, and the session mechanism allows ambiguity that might arise during parameter capture to be resolved. For example, if the user initially states a desire to “record a discharge note”, to which the for example, mobile device then prompts the user to specify “which patient?”, and afterwards, the user then states a command to “show patients from last week”, the system may prompt the user to specify what “last week” refers to admission date or discharge date, and the answer to this question may be disambiguated to refer to the second session started for the “show patients from last week”, because the answer matches the semantic type of the parameter needed by the second command/session and none of the semantic types of parameters needed by the first command/session (if such ambiguity existed, the mobile device would prompt the user for disambiguation), and further, once the list of patients from last week is displayed and a patient is chosen, it may be used as a parameter to the first command/session as patient is the type of information originally required by the first command/session. In other words, multiple command sessions may be active at once, objects captured by the mobile device either through prompting or context can be used to satisfy parameters for any of those command sessions, and if there is ambiguity, the mobile device can prompt the user to disambiguate.

While other systems for multi-modal interaction may have been conceived, this mechanism implemented by the for example, mobile device software and at least one of the computer servers permits customizations to speech patterns and command definitions to be made without a change to the underlying mobile device/server software.

In still yet another exemplary embodiment of the invention, the present invention relates to healthcare forms which evolve over time to improve processes, respond to changes in regulation, and/or fix errors, and when health records recorded relative to a set of original form layouts need to be migrated onto a set of newer forms with new form layouts, there is no unnecessary downtime or requirement of new versions of the mobile device/server software,

In most other EHRs today, where form template changes are generally discouraged not just because of the effort needed to update hard-coded templates to produce a new version, but also because of the need to migrate data to a new template version, as mentioned above. There are very few general methods for dealing with updates, and so most often custom tools are developed to do migrations when upgrading to a major new version is done. Such upgrades are not done frequently due to possible downtime and the possibility for errors during the upgrade.

The present invention meets the above challenge by allowing the technician to define a conversion mapping HSD document such as JSON document that resides on at least one computer server that maps data fields that exist on a set of original form layouts onto fields on a set of updated/new form layouts.

The conversion mapping as defined by the technician may include a combination of straightforward mappings (e.g., property “dob” needs to be mapped to property “dateOfBirth”) as well as more complex mappings that can be defined with script code such as JavaScript code.

The device, for example, the mobile device software may then, using the identity of a user logged in to the system responsible for maintaining patient records, perform the needed transformation in the following manner:
the mobile device software begins by identifying and locking all relevant (i.e., those that use the original and/or new form layouts indicated) health record HSD documents such as JSON documents on at least one computer server;
the mobile device software iterates through each data field referenced in the pre-transform side of the conversion mapping and for each health record document with the field: (a) the mobile device software identifies the form layout associated with the post-transform data field the field is mapped to; (b) if a health record document corresponding to that same patient (and possibly also same encounter ID or other relevant grouping mechanism) does not yet exist, one is added on the computer server and locked; (c) the data is mapped over and written into the corresponding post-transform data field on the target health record document (which was either already existing, created in (b), or actually the same document as the source health record document); (d) the changes are saved to the computer server;
at the end of the process, the mobile device software releases the locks on all touched health record JSON documents on at least one computer server; and
the mobile device software then presents the user with a report of the mappings that occurred. If some of the mappings could not take place because (a) someone else had locked a needed document; (b) data was improperly formatted; (c) an inconsistency was detected in the conversion—the mobile device reports these issues to the user.

The process just described may be repeated as many times as needed, as each run incrementally moves the health record system towards the target converted “state”. In this manner, the system has the same property as a GPS navigation device in that repeated attempts to run the process, regardless of the issues encountered en route, results in getting closer to the target destination state.

Another major benefit is that locked documents may still be referenced and seen by other users in the system even during the conversion and only momentarily inhibits further changes being made to specific documents being processed by the conversion by the, for example, mobile device software.

In some exemplary embodiments, the EHR system of the present invention may be based on having the configuration of most aspects of the system exposed to administrators in the form of system objects, which may, for example, be defined using YAML syntax and exist as, for example, HSD documents such as JSON documents in the system, as discussed above. In this fashion, various changes and/or modifications to the exposed “front end” of the EHR system may be achieved without altering the underlying EHR system “back end”. Changes and/or modifications may include, but are not limited to, modifying forms, creating new workflows,

In some embodiments, the EHR system of the present invention may employ a basic system object, such as, for example, a form layout, which may define how information and/or collections of information are presented to a user, such as in a visual representation, for example, a form, and/or how inputted information is structured and/or recorded in the EHR system.

In some embodiments, a template may be used to display and/or organize a series of individual information presenting and/or gathering components to a user as a form, which may be visually similar to electronic and/or paper forms commonly employed in a healthcare setting. For example, the individual information presenting and/or gathering components may be form widgets, such as, for example, HTML widgets, which may then be utilized by a user as the interface on a device for entering and/or retrieving information. The form widgets themselves may be embedded into the forms and/or reports being displayed on the user interface of the EHR system of the present invention. The information and structure of the information may then be stored within a, for example, HSD document such as JSON document in the persistent storage of the EHR system of the present invention on at least one computer server.

A variety of widgets may be utilized, such as to simplify gathering different kinds of information, and may include, but are not limited to, text inputs, dates and times, blood pressure readings, codes based on a standard vocabulary, pictures and/or photos taken from the device, and/or any other appropriate widget. Widgets may also be divided into sections and tables in order to facilitate navigation. As data is collected from the user, values for the information may be recorded via the widget, which may further be recorded under keys that are defined by the template, and placed into a HSD document such as JSON document. In this manner, the user interface of the form may be utilized to present the underlying HSD document such as JSON document for inspection and modification by the user in a user-friendly, administrator-defined fashion, as per the template utilized.

In some embodiments, macro sets may be utilized to specify a set of macros to appear in the EHR system of the present invention when information is being manipulated in the user interface. For example, when a macro button is pressed, the text corresponding to that macro button may be inserted into an active text field. The text may be dynamically generated by a script defined in the macro set that, when run by the mobile device, obtains potentially context-relevant data from at least one computer server such as a patient's allergies or demographic information to include in the inserted text. Macro sets may be targeted at specific fields on forms, specific users, and/or specific groups. In this way, users who have a need to quickly type in commonly used text snippets and/or other information may have the interface customized to suit their needs, which may enable them to enter information more efficiently.

In general, as any given record in the EHR system, such as a patient record, grows over time, certain pieces of information may inevitably be collected over and over again, such as, for example, allergies and active medications. For example, there may be clinical and/or auditability requirements which may require the information to be collected multiple times, which may result in the latest up-to-date information potentially being scattered across multiple documents. For example, a patient may state a certain allergy during one encounter, but forget to mention it at the next encounter.

In some exemplary embodiments, the EHR system of the present invention may provide a reconciliation capability to allow information collected from the same and/or a related form templates across multiple documents to be presented together and to enable the user to choose which, if any duplicate and/or conflicting entries to keep and which to discard. Unlike in a paper record, the information in the EHR system may be structured and/or identifiable by the EHR system, such as by being keyed as discussed above, such that a search may enable the same and/or related information to be agglomerated easily, as opposed to a paper record where a user must manually sift through all of the applicable forms to retrieve the information. Further, in the paper record, the information may not be easily pulled from the scattering of paper documents onto a single document, as opposed to the EHR system, or information may be missed during review of paper documents during a rushed review or when time is of the essence.

In addition, unlike a paper record, where the only means for organization and/or reorganization are generally re-ordering pages, inserting cover/separator pages, and/or attaching tape flags or the like, electronic records may generally be re-sorted essentially instantaneously to meet the needs of the work being done at the moment. For example, the subset of documents of interest to lab technicians in a patient record may be somewhat different than the subset of interest to, for further example, receptionists admitting patients. In paper form, where the pages cannot be reorganized for one user as opposed to another except by having multiple copies of the same record in various orders which may cause problems in patient care, the present invention allows the subset of documents of interest to one group of users, for example lab technicians, in a patient record may be somewhat different than the subset of interest to, for further example, receptionists admitting patients. Existence of multiple copies can also create problems and undue expenses in auditing, these problems and expenses are not created with the EHR system of the present invention.

In an exemplary aspect of the present invention, the EHR system of the present invention may utilize table of contents (TOC) system objects to define a dynamic organization for documents in a patient record. In some embodiments, documents may be dynamically organized by the TOC into a tree structure which may be similar to the standard “folder paradigm” most users of desktop computers are familiar with. For example, unlike the table of contents for paper books and the like, the EHR system of the present invention may utilize TOC definitions which may not be static, such that they may be adapted, for example, on a per-user basis, based on situational needs and/or based on the role(s) of the user (e.g., doctor, lab technician, etc.). The TOC may thus be customized for the particular user and/or the particular needs of a situation, such as to provide an efficient and/or intuitive organizational scheme to navigate through information in documents. Further, the EHR system TOC may operate as a navigational tool, rather than actually governing the manner the information itself is stored within the system, as opposed to common file folder hierarchy-type file systems.

In some embodiments, the root TOC level may define a menu of choices presented to the user. The menu of choices may further contain a mix of documents. such as, for example, a Basic Patient Information document, reports (e.g. “Blood Pressure Over Time”), and/or links to other TOC levels, which may be similar in appearance and/or usage to sub-menus in a typical desktop system. The menu may typically be defined as a series of queries to the database of the EHR system of the present invention, and the queries may be very specific, such as, for example, “show the patient's one and only Basic Patient Information document”, broad, such as, for example, “show all radiology images for this patient”, and/or any intermediate specificity. Menus may also be typically divided into multiple sections for ease of navigation and may also include buttons and/or other control features that may allow new documents and/or levels of organization to be added. For example, a menu may include a section that lists all radiology images for a particular patient, and a button and/or other control feature may be configured to appear in that section to give the user the option to add information, such as, for example, a new image.

In some examples, TOC levels may contain links to other TOC levels, and thus users may choose to view documents along different axes depending on the particular task and/or situation. This flexibility is in direct contrast to a paper system, where physical pieces of paper can only be ordered one way or another, and reordering is time-consuming. For example, by defining a TOC sub-level in the EHR system of the present invention, such as, for example, for patient encounters, and placing links to the patient's different encounters in the root TOC level, clinicians may view the information collected on a patient by encounter. At the same time, for further example, one may also define a different TOC sub-level, such as, for example, for billing accounts, and place links to these accounts in the root TOC level. These links may then provide, for example, billing specialists in the accounting department with a different view into the exact same patient record documents that is more attuned to their needs in a manner that is not possible with a single paper record.

In yet another aspect of the present invention, the system objects utilized by the EHR system of the present invention may generally be treated similarly to other institutional knowledge by an institution and may thus be backed up, versioned, updated in accordance with a defined change process, and/or otherwise treated in a similar manner to other institutional knowledge subject to management.

In some exemplary embodiments, system objects may generally define virtually every aspect of how users interact with the EHR system of the present invention at their institution. As such, the entire collection of system objects may be backed up, versioned, updated in accordance with a defined change process, etc. For example, at the beginning of an EHR system rollout, an initial version may be produced based on a combination of generic definitions for various items, such as, for example, tables of contents, patient form layouts, institution-specific customizations for patient admissions and/or lab processes. The next version and/or following versions of the system object collection may then be introduced in various ways to minimize disruption to the continuing operation of the EHR system at the institution. It may be desirable to perform updates on these system objects on a copy or instance of the EHR system of the present invention which may be dedicated to development and testing, and thus separate from the main operating instance being used by the institution. Thus, when the design work and/or other updating is complete and/or approved, the new collection of system objects may be copied to a training instance of the EHR system of the present invention, which may also be separate from the main operating instance, such as to allow the staff and/or other users to become familiar with the new changes without affecting the continuing operation of the main operating instance of the EHR system of the present invention at the institution. After adequate training, debugging and/or other finalization, the system object collection may then be pushed to production servers such that it may become part of mainstream use in the institution in the main operating instance of the EHR system of the present invention.

In some embodiments, the EHR system of the present invention may provide for managing versions of the system object collection by utilizing a synchronization tool which may facilitate transfer of system object definitions between instances of the EHR system of the present invention, such as, for example, between a development and testing instance, a training instance and the main operating instance. In one embodiment, the synchronization tool may utilize methods of identifying versions of system objects such that there may be minimal ambiguity when synchronizations occur. For example, the synchronization tool may identify different versions and give users the option of copying an updated version of a system object from one instance to another, such as, for example, on an individual basis, or for further example, en masse or as batches.

In other embodiments, the EHR system of the present invention may provide for managing versions of the system object collection by utilizing standard software development source control practices which may generally treat every system object as a source file that may be checked out and updated from a source control repository. For example, the EHR system of the present invention may utilize, for example, a git repository for the source files of the system objects. Source control may, for example, generally enable larger sets of personnel to work on updates at the same time and/or manage the changes that are introduced by each in a more systematic fashion. For further example, standard software development source control practices may also employ well-established best practices for backing up and maintaining repositories, such as git, that may be implemented to safeguard system objects utilized by an institution.

In some exemplary embodiments, the EHR system of the present invention may further include features for modifying and/or customizing system objects which may be accessible directly from the user interface on a device. This may be desirable as forms, templates, and/or other system object components of the EHR system of the present invention may be modified and/or customized on the fly instead of being wholly dependent on time-delayed development and/or customization. For example, customization may thus occur on-site and/or during the course of using the EHR system of the present invention rather than waiting for long development/update cycles to occur. In some embodiments, system objects may be created and/or edited using a subset of YAML syntax directly from within the user interface of the EHR system of the present invention.

In another aspect of the present invention, the EHR system of the present invention may utilize workflows to facilitate and/or conduct the review and/or approval of documents by a set of users.

In some embodiments, work queues may be utilized and may include a list of documents that have been posted for consumption, review and/or approval by a recipient, in a similar manner to an inbox of an email system. In general, the EHR system of the present invention may provide a work queue for each user and/or a single work queue for each group of users. The EHR system user interface may further include a dashboard where users may view the lists of documents that have been posted to their own work queues and/or the work queues of any groups to which they belong.

In general, posting a document to a work queue may not remove it from anywhere else in the EHR system of the present invention, such as, for example, from the patient record and/or other accessible location, but rather work queues may merely contain links to the documents that have been posted to them. For further example, when a document is removed from a work queue, in general only the link may be deleted from the queue while the underlying document is not affected or deleted. In this manner, the EHR system of the present invention may take advantage of an electronic system, such as with document check-in and check-out features, which may enable the EHR system f the present invention to preserve the underlying documents in a central storage while enabling them to be linked, visible and/or otherwise accessed from various parts of the EHR system of the present invention without creating conflicts.

In some embodiments, the documents in a work queue and/or workflow may require review and/or approval by certain users, such as, for example, before the documents may progress in the workflow. In one embodiment, the documents in the workflow may be signed by appropriate users to continue the workflow. In one embodiment, a document may be said to have completed its workflow if signatures are collected from all necessary users and/or parties. The list of necessary users and/or parties may be determined based on the workflow steps.

In general, signatures may be digital signatures or manual signatures. A digital signature may be created, for example, by using a public/private key pair that may be generated for each user when he/she signs a form for the first time and may further be protected by a password or other encryption key, which may be utilized as the user's signing password. Digital signatures in the EHR system of the present invention may use, for example, a hash of the HSD such as JSON property values visible to the user on the form, which may be desirable to enable auditors to confirm that the signature is authentic and/or that the signature corresponds to the data shown on the screen at the time of the signature.

A manual signature may also be utilized, and may essentially be a piece of human-readable evidence that may generally take the form of a traditional written signature, which may also be given a visual representation in the user interface of the EHR system of the present invention. Manual signatures may be stored, for example, in a property of the document that is declared to the workflow system using a property of the template for the document. Unlike a digital signature, a manual signature may generally not be authenticated by the EHR system per se and the EHR system may therefore, for example, require the user to attest that the manual signature has been captured properly on behalf of an authorized submitter as part of, for further example, auditability.

The submitter of a document in a workflow may generally be the user who initiates a particular workflow process; however, the submitter may not necessarily be the same as the person who submits the document at the end of a step in the workflow. For example, many institutions allow for telephone orders and/or orders received by fax or other paper-based means, and thus the person submitting a document may be acting on behalf of the actual submitter of the document, such as, for example, a physician, which in the case of an order may be the only type of user authorized to legally submit an order.

In some embodiments, submissions in a workflow may be restricted in the EHR system of the present invention such that only authorized and/or proper users may submit. For example, if a user does not belong to one of the specified user classes in the EHR system of the present invention, the EHR system may prompt the user to specify which user on whose behalf the form and/or other workflow item is being submitted. In this manner, for example, a user may enter a telephone, fax and/or other remote order, which may cause the EHR system of the present invention to start the workflow as if the authorized user had already signed and/or also in parallel (i.e., not obstructing the normal workflow) place the document into the queue of the authorized user to do a final signoff. In embodiments using a manual signature, the EHR system may create a digital signature based on, for example, the public/private key pair of the user that actually entering the submission, while also incorporating the identifying information of the user on whose behalf the submission is actually being made.

In general, the steps of a workflow may specify the order in which signatures and/or other authorizations are to be collected. A step may either specify a particular user and/or a group of users that indicates the kind of signature that may be needed to complete a step. For example, if a step specifies a particular user, the step is considered complete if the document has collected that user's signature. For further example, for a step specifying group of users, a signature from any user in that group may be sufficient. Thus, the EHR system of the present invention may examine the workflow steps sequentially to find the first step that has not been completed when submissions are made in the workflow. The particular user and/or group of users of that step may further determine the particular work queue into which the document is placed. Thus when all steps are completed, the document may be placed in the completed queue, such as may be defined by the template of the document. Notes may also be incorporated into the various steps of the workflow, such as, for example, to enable users to annotate and/or comment as the workflow progresses. A notes widget may be included in a form by the template such that notes may be easily added from the user interface of the EHR system.

In addition, in the present invention, the electronic health record is not only for use by a single institution but multiple institutions and the possible users are not only healthcare professionals but also the patient or patient representatives such as guardians. The customization capabilities described above may also be leveraged to provide simplified and/or read-only access to health record forms. In addition, the health record forms may be auto-filled or created automatically based on health data captured by the patient's own portable devices, such as heart rate, exercise patterns, weight, etc. The patients thus benefit from being able to see all of their health data, not just that which could be copied over to a (probably non-customizable) personal health record (PHR) system of existing art, and patients can also be part of workflow approval processes if consent is required to perform certain actions such as the transmission of information over the Internet to other providers. Personal health data that are exposed from the master record and/or captured from personal devices may all be configured through system objects sitting on at least one computer server, hence not requiring different versions of mobile device/server software for each customized configuration.

As mentioned above, healthcare professionals across multiple institutions may also be included in the list of possible users. For example, it is possible to use the EHR in a much larger setup, encompassing systems of hospitals/clinics, or even an entire insurance population (this is known under names such as “population health” or “accountable care organization”). Since customizations may be made at a granular level, doctors in different clinics may have different requirements but they can share the same electronic health record system, using forms and processes that are customized at a per-doctor, per-clinic/institution, or per-policy level, all without specialized versions of the mobile device/server software. The scalable nature of the backend computer server makes it possible to support an extremely large number of users. The benefit of this approach is that patients are able to obtain care from multiple providers that in the past would have had to use fax machines or couriers to exchange printed versions of health record forms because of incompatible systems. With the approach of the present invention, these providers are using a system that accounts for the differences in the form layouts within the same environment.

Further, the present invention includes messaging as one of the list of applications for healthcare forms. The forms mechanism may enable support of two-way or n-way messaging amongst patients and healthcare professionals.

In other industries, similarly, the present invention relates to systems and methods for managing their respective relevant information on a highly scalable and customizable software and hardware architecture operable on, for example, devices including portable devices and minimal downtime during upgrades and scaling. This invention further relates to systems and methods for efficient access and customization of forms for electronically generating and managing, for example, information. All the embodiments and aspects applicable to healthcare noted above, are also applicable to these other industries.

For example, in customer relationship management, instead of patients, there are customers; and instead of health record forms, there are records of customer interactions. In human resources, instead of patients, there are employees; and instead of health record forms, there are things like performance reviews, benefit elections, etc. In accounting, instead of patients, there are payees/vendors/suppliers; and instead of health record forms, there are forms for different transaction types that could be recorded. In project management, instead of patients, there are projects; and instead of health record forms, there are forms for tasks to complete, work assignments, and feedback from stakeholders. In the area of volunteers in the field, for example, a political campaign, instead of patients, there are potential voters; and instead of health record forms, there are forms for different political issues to record.

The present invention together with the above and other advantages may best be understood from the following detailed description of the embodiments of the invention as illustrated in the drawings.

### BRIEF DESCRIPTION OF THE FIGURES

FIGS. 1 and 1a illustrate dashboard views of the user interface of an EHR system of the present invention;

FIG. 2 illustrates a work queue view of the user interface of an EHR system of the present invention;

FIG. 3 illustrates a set of appointment and scheduling widgets in a view of the user interface of an EHR system of the present invention;

FIGS. 4 and 4a illustrate sets of patient information widgets and a TOC in a view of the user interface of an EHR system of the present invention;

FIGS. 5 and 5a illustrate auto-filling behavior in certain input fields of widgets in a form;

FIGS. 6 and 6a illustrate TOC sub-level behaviors in the user interface of an EHR system of the present invention;

FIGS. 7 and 7a illustrate a system object editor accessible from the user interface of an EHR system of the present invention;

FIG. 8 illustrates an example of a form with a variety of widgets in a view of an EHR system of the present invention.

### DETAILED DESCRIPTION OF THE INVENTION

The detailed description set forth below is intended as a description of the presently exemplified systems, devices, methods and materials provided in accordance with aspects of the present invention, and it is not intended to represent the only forms in which the present invention may be practiced or utilized. It is to be understood, however, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any systems, methods, devices and materials similar or equivalent to those described herein can be used in the practice or testing of the invention, the exemplified systems, methods, devices and materials are now described.

The names of persons appearing herein, either in the written specification or in the drawings, are intended to be completely fictitious and do not represent any real persons, living or dead. Any similarity to the name or characteristics of a real person is completely unintentional, coincidental, meant to be obviously fictitious and/or for illustrative purposes only. Nothing herein should constitute or construed to be professional advice or treatment.

As mentioned above, one of the biggest expenses in bringing any EHR online for a group of medical professionals is the time spent implementing an institution's existing workflows and processes within the system. Although most institutions share the same basic concepts of encounter, patient account, order, laboratory result, and protocol, the exact way these concepts are stitched together to drive patient care from admission to discharge can differ significantly even from hospital to hospital. Often it takes a gradual process to identify and discern the interconnections amongst the different pieces of an institution's workflows and processes. To sustain this journey, EHR systems need to accommodate small, incremental, potentially frequent changes to the system configuration in order to “get it right”. At odds with this requirement is the fact that the definitions of forms, workflows, and other aspects of the system are sometimes hard-coded into the EHR itself, requiring the allocation of highly-skilled developers' time to implement. Once institutional customizations start to entail changes in the underlying EHR product, the notion of frequent incremental changes can turn out to be impractical. This is especially so for EHRs that requires downtime to accomplish any changes or upgrades.

Previous generation systems were also often designed to run on a single server. When the single server became overloaded, the solution was often to replace the server with a larger, more powerful server. High availability was achieved by doing everything possible to keep that single server from failing and having an identical backup server on standby. Finally, upgrades were performed by scheduling an outage for the server and updating the software and doing a smoke test as quickly as possible to minimize downtime.

The present invention relates to systems and methods for inputting information electronically and for storing such information on multiple servers, which may include cloud servers, for easy accessing, managing, sharing, and organizing such information with minimal down time during scaling and upgrading. Unlike exiting systems, the present invention is designed to run across multiple servers and to distribute the workload evenly across these servers. Because every tier of the application includes essentially identically-configured worker nodes, individual nodes can fail and/or be taken down for maintenance or upgrades while minimally impacting the availability of the overall system. To support a larger number of users or records, one simply adds more servers to these pools.

In addition to highly scalable and customizable software and hardware architecture to minimize downtime during upgrades and scaling, the present invention also emphasizes portable devices.

In one aspect of the invention, an electronic health record system (EHR) of the present invention, which may also be referred to as an electronic medical record system (EMIR), may be deployed and run on a plurality of servers over which the computing and/or storage load may be distributed in a non-centralized manner such that the overall system may remain up and operating even while being scaled, upgraded and/or otherwise modified. In some exemplary embodiments, an EHR system of the present invention may be a software application that may generally include a plurality of essentially identically configured worker nodes that are deployed and run on a plurality of servers in a server pool. In the present invention, the EHR system may distribute its workload and/or storage load across the servers in the server pool, such as, for example, substantially evenly across the available servers in the server pool. Since the EHR system may include a plurality of essentially identically configured worker nodes, individual worker nodes may be taken down, fail, and/or be modified without affecting the other worker nodes and/or significantly impacting the overall operability of the EHR system. This may be desirable as the EHR system runs the operations of any healthcare facility and in such medical settings where the need to access patient information is, for example, often time-sensitive and essential for proper patient treatment, experiencing minimal or no downtime once deployed may insure smooth operations without unnecessary interruptions. In this manner, for example, the server pool may have additional servers added in and/or servers taken down, whether for replacement, upgrade, repair or otherwise, at almost any given time to modify the system experiencing downtime due to server modifications, thus minimally impacting the availability of the overall system.

In some embodiments, the EHR system of the present invention may be built on a highly-automated installation platform where individual components of the system may be packaged into separate images, which may include the configurations of the specific components. The system may create and run instances of the components from the images while keeping any data generated meant to be persistent stored separately from the image in persistent storage. Thus, the system may create and dispose of instances of the components at will without loss of either configuration information, which is stored in the image, or persistent data, which is stored in persistent storage. The separate EHR system components may then be taken down for upgrades, repairs and/or other modifications without affecting other components.

In one embodiment, the EHR system of the present invention may be built on an automated installation platform, for example, “Docker”. “Docker” may generally leverage Linux Containers, a technology built into Linux that is lighter weight than traditional virtualization methods. The components of the EHR system of the present invention may then be packaged into “Docker” images. Images may then be started within “Docker” to produce running instances of the components. In a traditional environment, for example, these instances may be akin to an installed piece of software running on a stack of middleware and other components for which significant time and energy are invested in configuration. In contrast, instances of the EHR components in this embodiment may generally be easy to create and may be disposable when, for example, repairs, upgrades and/or modifications to the EHR system are desired or necessary. “Docker” may also generally allow for separation of configuration data for each component, which may be stored in the “Docker” image, and persistent data, which may be stored in persistent storage. The instances of each component may thus be disposed of at any time because the configuration of the instance may be recreated at any time by, for example, launching a new instance based on the same original image, while the persistent data managed by the instance is not stored in the instance itself but in a persistent storage, such as a backend, for example, a network attached storage (NAS).

In some embodiments, persistent data may be stored using a scalable backend database system which may generally utilize non-relational database structures, but may rather utilize a discrete document-centric structure which may further leverage scalability, document replication and/or load distribution on a server or storage pool. The database system may also, for further example, utilize a document checkout system where documents remain viewable to all allowed users, but only one user may modify the document at a time by checking it out of the database. This may be desirable to prevent, for example, concurrent modification of documents which may introduce conflicting information. This is especially desirable in the healthcare area, where conflicting information may have life and death consequences.

In one exemplary embodiment, the scalable backend database system may employ a NoSQL database such as, for example, “MongoDB”. Some databases, such as “MongoDB”, may be specifically designed to manage and store extremely large numbers of HSD documents such as JSON documents in a scalable fashion.

In another aspect of the invention, the EHR system may be designed to be primarily accessed, maintained and utilized almost entirely from portable or mobile devices with only certain functions requiring direct access to a server and/or a stationary computer. This is unlike most EHR systems in general, which are designed for use with stationary computers with any mobile access or functionality being an afterthought. This in general reflects a more traditional or dated approach to maintaining health records which are more akin to paper and file room systems that do not significantly leverage any technological advances that allow for a different approach to managing information. In this aspect, the EHR system of the present invention may generally be utilized immediately and at the point of contact with patients and/or during actual occurrences requiring entry and/or retrieval of information, rather than after the fact. This may, for example, aid in increasing efficiency and/or fidelity of information as after-the-fact recordkeeping may inherently introduce error and/or incompleteness due to later inaccessibility to the source of information.

In general, accountability and auditability are important concepts in the medical field. As accurate patient records are relied heavily upon to make informed clinical decisions, the EHR system of the present invention may be designed to track all changes that occur to patient records by, for example, date, time, user and/or any other appropriate manner. The EHR system may also generally store all and/or a desired selection of past versions of documents in the database to facilitate audits. Users of the EHR system may also facilitate auditability through the use of the check-in and check-out actions available in the EHR system, as these actions may generally, for example, also prevent multiple users from making potentially conflicting modifications to any given document.

In some embodiments, all primary users of the EHR system of the present invention may utilize a portable or mobile device for their access and utilization of the EHR system. In one embodiment, iPad®, Android®, Windows® tablets and/or other similar tablet computing devices may generally be utilized. In general, it may be desirable for the EHR system of the present invention to be utilized from a popular, widespread and/or familiar computing platform, as this may allow, for example, users to concentrate on their actual tasks rather than trying to figure out an unfamiliar and/or overly complex software interface. In addition, popular and/or widespread computing platforms may generally benefit from diligent technical support, issue familiarity, updates and/or availability of replacements. The EHR system of the present invention may generally be utilized on any appropriate device, which may include, but is not limited to, a smartphone, a tablet computer, a personal computer, and/or any other appropriate computing device. In general, the EHR system of the present invention may employ a graphical user interface (GUI) and depending on the device, it may be accessible with a touchscreen interface and/or a keyboard/mouse interface, whichever may be appropriate. The EHR system of the present invention may also employ other forms of interface, such as those designed for use with visually and/or hearing impaired users, and/or alternative interfaces, which may include, for example, voice recognition and/or playback, Braille computer interfaces, haptic interfaces, and/or any other appropriate interface.

In a further aspect of the invention, the EHR system of the present invention may utilize a highly customizable architecture that may generally enable the EHR system to be customized to fit any particular needs of the user(s) without any drastic changes to the underlying functionality and/or design of the EHR system. In some exemplary embodiments, the EHR system architecture of the present invention may be based on having the configuration of most aspects of the system exposed to administrators in the form of system objects, where, for example, changes including, but no limited to, adding a field to a form to creating a new workflow for handling lab orders are all achievable without changes to the underlying EHR system of the present invention. System objects may generally be defined using the YAML syntax and may exist as HSD documents such as JavaScript Object Notation (JSON) documents in a similar fashion to all other documents (such as patient records) managed by the EHR system.

With most existing EHRs, there is a common problem: forms and processes need customization to meet the needs of individual institutions, for example, hospitals. To solve this problem, most of these EHRs employ hard-coding form and process definitions in code, which requires additional time and higher-skilled developers to create multiple custom versions of the product. That means either multiple versions of the electronic health record system software need to be created and stored on at least one server; or a higher-skilled developer may take time to create a custom version ad hoc, hampering the operation of the institution. Also, when multiple institutions want to have different customizations to their electronic health record system and if multiple versions of the device and/or server software are not created beforehand, these requirements for higher skilled developers and time can multiply.

The present invention solves the above mentioned defects and eliminates the need for higher skilled developers when custom forms are needed ad hoc without creating multiple versions of the electronic health record system software by leveraging the flexibility of documents storing data with a standardized syntax or format, such as for example, HSD documents such as JSON documents and a unique manner in which HSD documents such as JSON documents are dynamically processed on any appropriate device mentioned above. For example, health records may be stored as a series of HSD documents such as JSON documents on at least one computer server.

The present invention may utilize a form engine, for example, that may work off of form definitions that are provided as configuration files to the product. In this way, a lower skill level only is needed to customize the EHR for a specific hospital, and custom forms and processes may be defined in configuration files that may be updated without the need for custom versions of the base product.

For example, the form engine may work as follows: when a document is to be shown in the EHR to a user, the form engine retrieves the document from the database. Documents may be encoded as a series of key-value pairs in HSD such as JSON format. One of the key-value pairs may indicate the form template the document is based on. The EHR may then retrieve the form template from the database, which may itself also be specified as a series of key-value pairs in HSD such as JSON format. Form templates specify what fields may be shown on the screen (e.g., a field for gender or age), what kind of “widget” is to be used to capture the input from the user (e.g., a choice widget or a search widget for looking up a code), and how to store the value inputted by the user in the document (usually giving the “key” name for the key-value pair in the HSD document such as JSON document). In the final step, the EHR's form engine may create the actual form presentation on the screen of a user device, such as an iPad, one widget at a time, in sequence, reflecting the latest customizations at the time, and then populates the widgets with data from the document.

The present invention is also different from normal paper forms or forms in other applications, in addition to being more efficient and time saving. First, the forms are not hard coded, so only a configuration change may be needed to update/customize forms. Development skills are not needed for the personnel implementing the change, and a new version of the product does not need to be produced and/or a master form be printed and/or filed. Also, as the forms are not hard coded, the exact presentation shown to the user on the iPad may be optimized by the form engine at runtime. For example, with hard-coded forms, layout characteristics such as fonts and positioning on the screen are set explicitly. With the present invention, using the form engine, one abstract form layout specification may be used to produce a form user interface for a user device, such as an iPad, in landscape mode, portrait mode, and even for use in a web browser, depending on the space available on the screen. Further, the form input screens always reflect the very latest version prepared by the system administrators. There is no upgrade to be done to the iPads, the servers, or even to the data already filled in using old versions of the forms (in many cases). This is clearly in contrast with paper forms, where updates to the form template itself will not propagate back to copies of the forms that were already filled in. Furthermore, it is easier to control versioning on a per-form basis. For example, it is possible for multiple institutions to share form templates and be aware of the dates individual form templates were updated on. A given hospital may choose to roll out a new demographics form while delaying the roll out of a form used to capture vitals. This may not be possible in and is clearly in contrast to a system with hard-coded forms, where every permutation of different form template versions would require a different version of the product itself, a combinatoric explosion which may result in an unmanageable number of versions for an EHR vendor to track and keep up to date. Thus, in addition to not requiring higher-skilled developers, the present invention further simplifies not only the process, but minimizes the number of versions to track, thus minimizing the chances for confusion, and save time and effort.

In yet another aspect of the present invention, the EHR system of the present invention may be efficiently and easily customized for installation at a working site, such as, for example, a hospital, doctor's office, and/or other healthcare institution, without a great deal of “back end” customization of the EHR system in order to achieve a working implementation. In general, one of the biggest expenses in bringing an EHR online for a group of medical professionals is the time spent implementing an institution's existing workflows and processes within the system. Although most institutions share the same basic concepts of encounter, patient account, order, laboratory result, protocol, and/or others, the exact way these concepts are stitched together to drive patient care from admission to discharge can differ significantly from one institution to another. In many situations, a gradual process is used during a typical EHR implementation to identify and discern the interconnections amongst the different pieces of an institution's workflows and processes. Effective EHR systems are generally designed to accommodate small, incremental, potentially frequent changes to the system configuration in order to properly implement the EHR system so that it will work with the institution. Often, the definitions of forms, workflows, and other aspects of the system are sometimes hard-coded into the EHR itself, which often requires the allocation of highly-skilled developers' time to implement due to the required changes being done on the “back end”. Further in general, once institutional customizations start to entail changes in the underlying EHR product, the notion of frequent incremental changes can become impractical.

In some exemplary embodiments, the EHR system of the present invention may be based on having the configuration of most aspects of the system exposed to administrators in the form of system objects, which may, for example, be defined using YAML syntax and exist as HSD documents such as JSON documents in the system, as discussed above. In this fashion, various changes and/or modifications to the exposed “front end” of the EHR system may be achieved without altering the underlying EHR system “back end”. Changes and/or modifications may include, but are not limited to, modifying forms, creating new workflows, customizing reports, creating and/or modifying information input and/or display features, and/or any other appropriate changes or modifications.

In some embodiments, the EHR system of the present invention may employ a basic system object, such as, for example, a template, which may define how information and/or collections of information are presented to a user, such as in a visual representation, for example, a form, and/or how inputted information is structured and/or recorded in the EHR system.

In some embodiments, a template may be used to display and/or organize a series of individual information presenting and/or gathering components to a user as a form, which may be visually similar to electronic and/or paper forms commonly employed in a healthcare setting. For example, the individual information presenting and/or gathering components may be form widgets, such as, for example, HTML widgets, which may then be utilized by a user as the interface on a device for entering and/or retrieving information. The form widgets themselves may be embedded into the forms and/or reports being displayed on the user interface of the EHR system of the present invention. The information and structure of the information may then be stored within a HSD document, for example, JSON document in the persistent storage of the EHR system of the present invention.

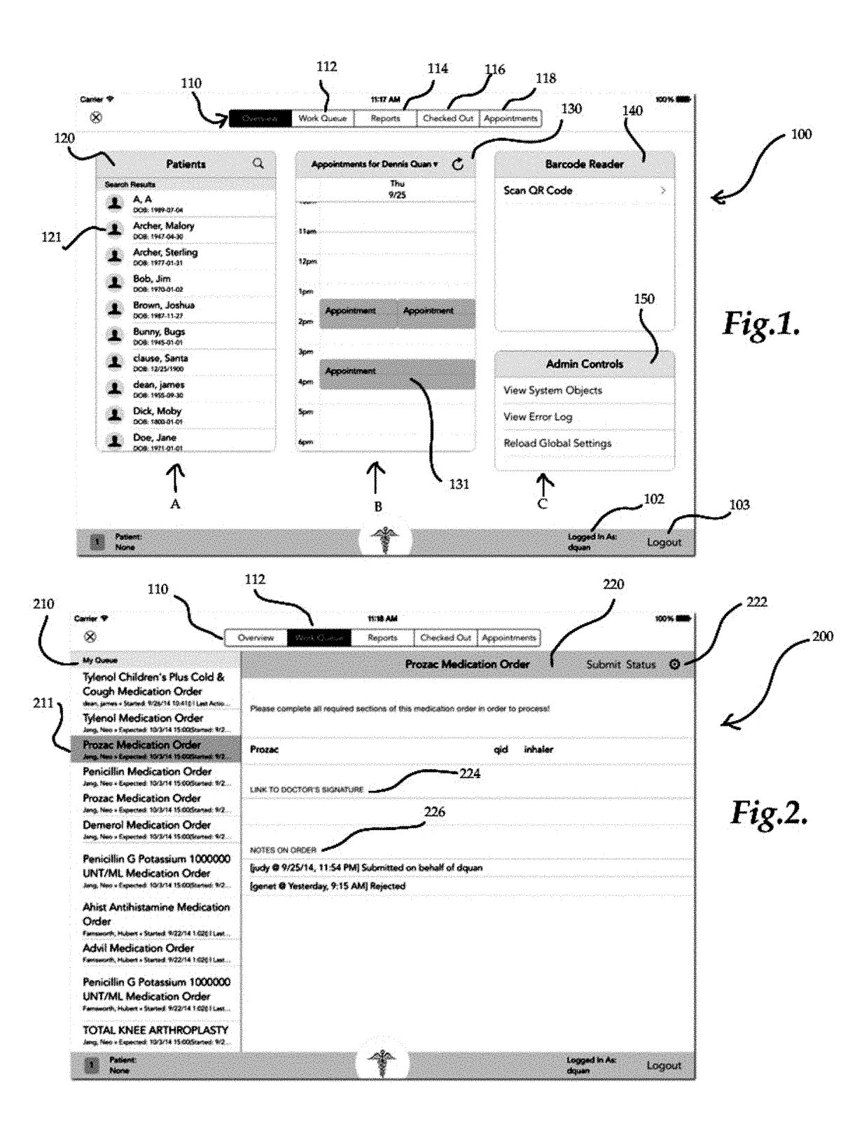

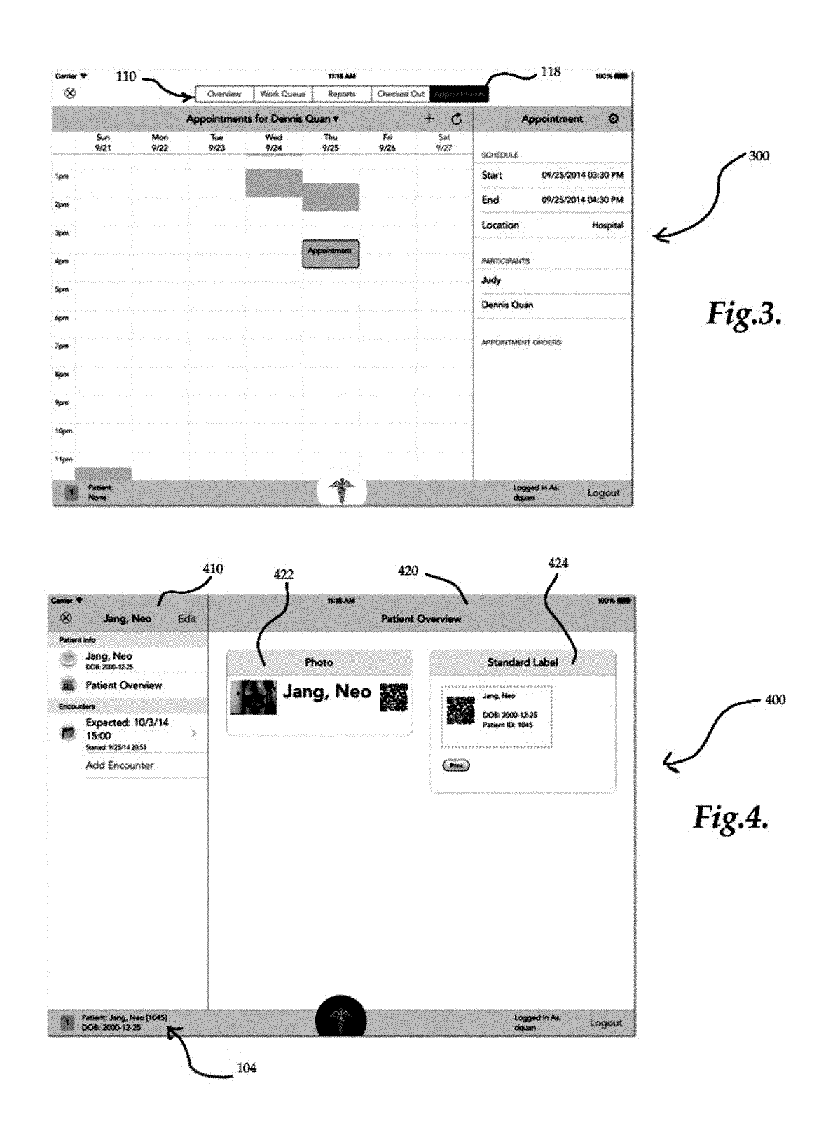

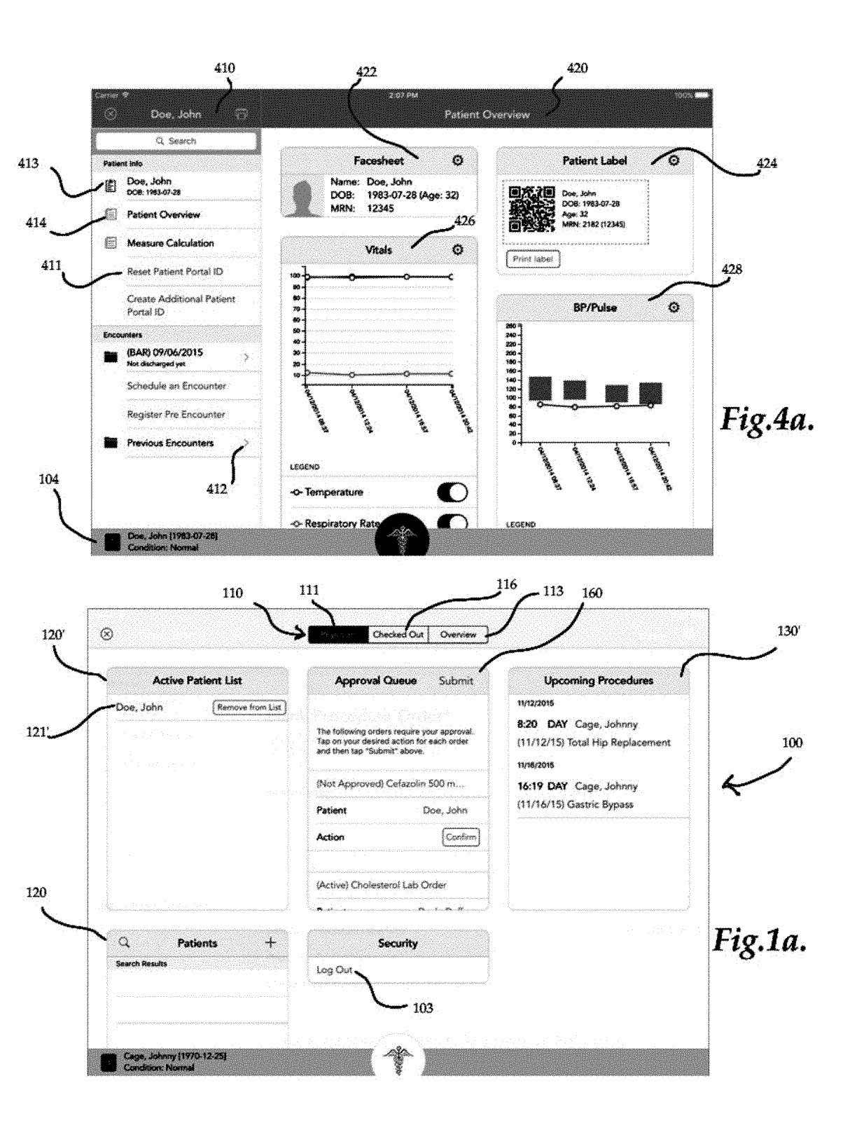

FIGS. 1 and 1a illustrate examples of a dashboard view 100 of the EHR system for a user in some embodiments of the invention. The EHR system user interface may generally indicate which user is logged in, if any, such as with the user logged in indicator 102, and may also generally provide a logout button 103. Information displayed in the EHR system user interface may generally be arranged in columns which may be customized to a user's preferences and/or to particular needs for tasks and/or situations, such as illustrated with columns A, B and C in FIG. 1.

A variety of widgets may be utilized, such as to simplify gathering different kinds of information, and may include, but are not limited to, text inputs, dates and times, blood pressure readings, codes based on a standard vocabulary, pictures and/or photos taken from the device, and/or any other appropriate widget. Widgets may also be divided into sections and tables in order to facilitate navigation. As data is collected from the user, values for the information may be recorded via the widget, which may further be recorded under keys that are defined by the template, and placed into a HSD document, for example, a JSON document. In this manner, the user interface of the form may be utilized to present the underlying HSD document, for example JSON document for inspection and modification by the user in a user-friendly, administrator-defined fashion, as per the template utilized.

In some embodiments, as illustrated in FIG. 1, the dashboard view 100 may, for example, contain a variety of widgets which may be defined by the template governing the dashboard view 100. Widgets may include, for further example, a navigation bar 110 for showing different views of the EHR system, such as, for example, the overview as shown in the dashboard view 100, the work queue view via button 112 of the user, reports via button 114, checked out documents via button 116 and via button appointments 118, a listing of patients 121 accessible and/or assigned to the user, such as in patient list 120, a schedule of appointments 130, and/or other appropriate widgets, such as, for further example, barcode scanner 140 and admin controls 150, as illustrated. FIG. 1a illustrates a dashboard view 100 with an example of an alternative arrangement and differing widgets and controls, as shown with navigation bar 110, for example, with buttons 111, 113, 116 for a particular professional (e.g. physician), overview and checked out documents, an upcoming procedures listing 130′, active patient list 120′ with patients 121′ and an approval queue 160, as illustrated.

FIG. 3 illustrates a view in the EHR system of a schedule of appointments 300 which may be accessible from the schedule of appointments button 118. The schedule of appointments 300 may include widgets for displaying existing appointments and/or enable entry/modification of appointments into a calendar of a user.

In some embodiments, macro sets may be utilized to specify a set of macros to appear in the EHR system of the present invention when information is being manipulated in the user interface. For example, when a macro button is pressed, the text corresponding to that macro button may be inserted into an active text field. The text may be dynamically generated by a script defined in the macro set that, when run by the mobile device, obtains potentially context-relevant data from at least one computer server such as a patient's allergies or demographic information to include in the inserted text. Macro sets may be targeted at specific fields on forms, specific users, and/or specific groups. In this way, users who have a need to quickly type in commonly used text snippets and/or other information may have the interface customized to suit their needs, which may enable them to enter information more efficiently. Text fields and/or other input items may also include standard vocabulary sets and/or preset options which may also be searchable.

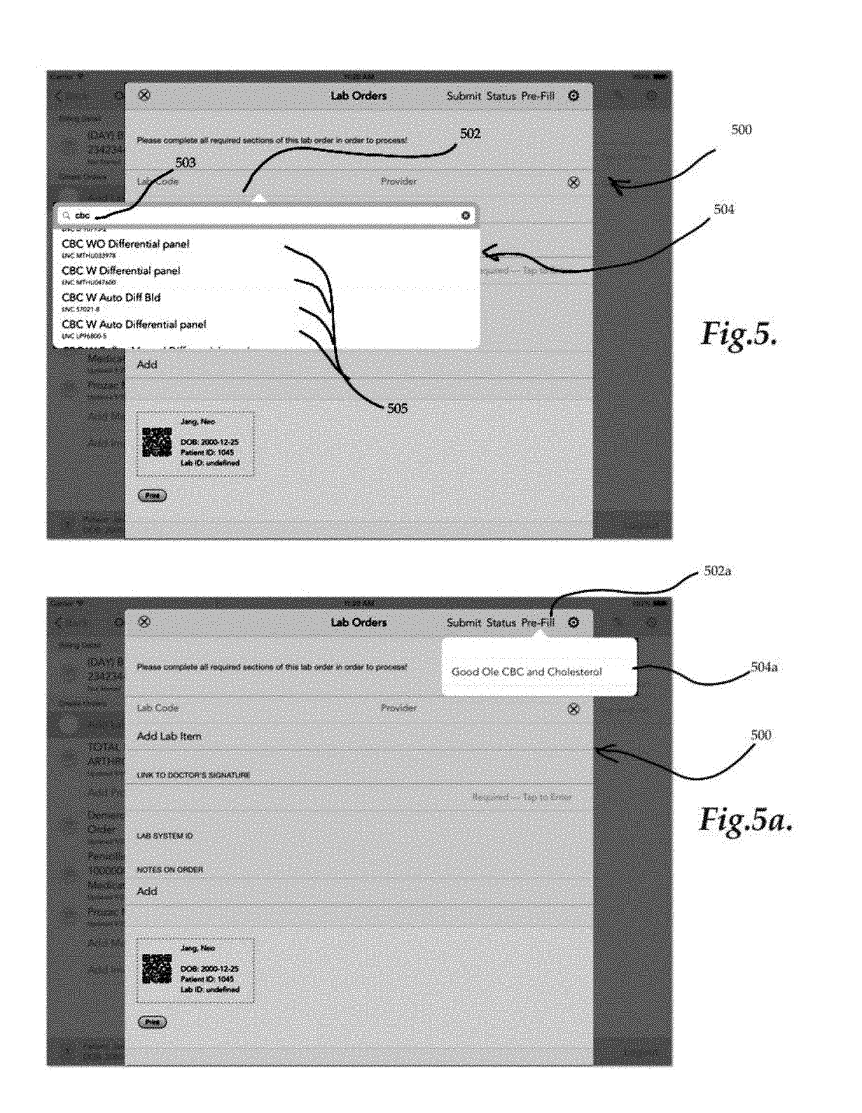

FIG. 5 illustrates an example of a text field 502 in a form 500 which displays a macro set of options 504 with options of insertables 505 after an initial input of some text 503. FIG. 5a illustrates an example of a button 502a in a form 500 which displays a macro set of options 504a when the button 502a is pressed, as opposed to requiring some input of information, such as the text 503 in FIG. 5.

In general, as any given record in the EHR system, such as a patient record, grows over time, certain pieces of information may inevitably be collected over and over again, such as, for example, allergies and active medications. For example, there may be clinical and/or auditability requirements which may require the information to be collected multiple times, which may result in the latest up-to-date information potentially being scattered across multiple documents. For example, a patient may state a certain allergy during one encounter, but forget to mention it at the next encounter.

In some exemplary embodiments, the EHR system of the present invention may provide a reconciliation capability to allow information collected from the same and/or a related form templates across multiple documents to be presented together and to enable the user to choose which, if any duplicate and/or conflicting entries to keep and which to discard. Unlike in a paper record, the information in the EHR system may be structured and/or identifiable by the EHR system, such as by being keyed as discussed above, such that a search may enable the same and/or related information to be agglomerated easily, as opposed to a paper record where a user must manually sift through all of the applicable forms to retrieve the information. Further, in the paper record, the information may not be easily pulled from the scattering of paper documents onto a single document, as opposed to the EHR system, or information may be missed during review of paper documents during a rushed review or when time is of the essence.

Also, unlike a paper record, where the only means for organization and/or reorganization are generally re-ordering pages, inserting cover/separator pages, and/or attaching tape flags or the like, electronic records may generally be re-sorted essentially instantaneously to meet the needs of the work being done at the moment. For example, the subset of documents of interest to lab technicians in a patient record may be somewhat different than the subset of interest to, for further example, receptionists admitting patients. In paper form, where the pages cannot be reorganized for one user as opposed to another except by having multiple copies of the same record in various orders which may cause problems in patient care, the present invention allows the subset of documents of interest to one group of users, for example lab technicians, in a patient record may be somewhat different than the subset of interest to, for further example, receptionists admitting patients.

In an exemplary aspect of the present invention, the EHR system of the present invention may utilize table of contents (TOC) system objects to define a dynamic organization for documents in a patient record. In some embodiments, documents may be dynamically organized by the TOC into a tree structure which may be similar to the standard “folder paradigm” most users of desktop computers are familiar with. For example, unlike the table of contents for paper books and the like, the EHR system of the present invention may utilize TOC definitions which may not be static, such that they may be adapted, for example, on a per-user basis, based on situational needs and/or based on the role(s) of the user (e.g., doctor, lab technician, etc.). The TOC may thus be customized for the particular user and/or the particular needs of a situation, such as to provide an efficient and/or intuitive organizational scheme to navigate through information in documents. Further, the EHR system TOC may operate as a navigational tool, rather than actually governing the manner the information itself is stored within the system, as opposed to common file folder hierarchy-type file systems.

In some embodiments, the root TOC level may define a menu of choices presented to the user. The menu of choices may further contain a mix of documents, such as, for example, a Basic Patient Information document, reports (e.g. “Blood Pressure Over Time”), and/or links to other TOC levels, which may be similar in appearance and/or usage to sub-menus in a typical desktop application. The menu may typically be defined as a series of queries to the database of the EHR system of the present invention, and the queries may be very specific, such as, for example, “show the patient's one and only Basic Patient Information document”, broad, such as, for example, “show all radiology images for this patient”, and/or any intermediate specificity. Menus may also be typically divided into multiple sections for ease of navigation and may also include buttons and/or other control features that may allow new documents and/or levels of organization to be added. For example, a menu may include a section that lists all radiology images for a particular patient, and a button and/or other control feature may be configured to appear in that section to give the user the option to add information, such as, for example, a new image.

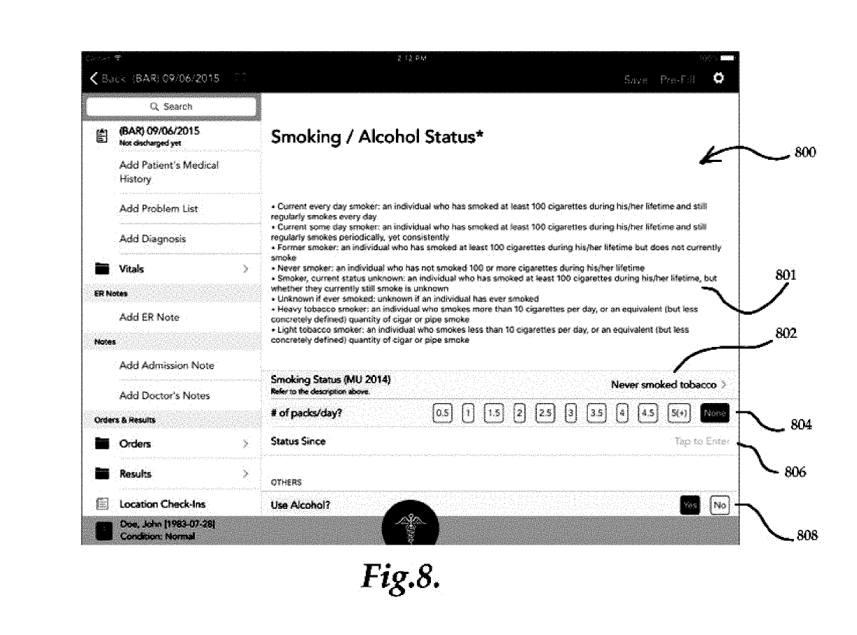

FIGS. 4 and 4a illustrate a view in the EHR system of a report on a patient 400, which may include, for example, a TOC 410 displaying a hierarchy of documents available for that patient, and a widget(s) for displaying particular information from documents 420, such as, for further example, the photo widget 422 showing the patient's picture and the label widget 424 with a QR code for the patient. Other widgets may also be utilized, such as HTML widgets, as illustrated, for example, with widgets 426, 428 which may be utilized to display vital sign records and heart rate/pulse, respectively, in FIG. 4a. Different items may also be accessible within a TOC, such as forms and reports, as shown with form link 413 and report link 414 in FIG. 4a. A TOC may also contain command items, as shown with command button 411. FIG. 8 also illustrates an example of a form 800 with a variety of widgets, such as, for example, simple text content 801, vocabulary search widget 802 for selecting from a provided list of options, a single choice widget 804 for selecting from several option buttons, a date entry widget 806, and a binary (e.g. yes/no) widget 808. An indicator of which patient being viewed may also be displayed, such as with patient indicator 104.

In some examples, TOC levels may contain links to other TOC levels, and thus users may choose to view documents along different axes depending on the particular task and/or situation. FIG. 4a illustrates an example of a nested TOC level indicator 412 which may open a TOC sub-level. This flexibility is in direct contrast to a paper system, where physical pieces of paper can only be ordered one way or another, and reordering is time-consuming. For example, by defining a TOC sub-level in the EHR system of the present invention, such as, for example, for patient encounters, and placing links to the patient's different encounters in the root TOC level, clinicians may view the information collected on a patient by encounter. At the same time, for further example, one may also define a different TOC sub-level, such as, for example, for billing accounts, and place links to these accounts in the root TOC level. These links may then provide, for example, billing specialists in the accounting department with a different view into the exact same patient record documents that is more attuned to their needs in a manner that is not possible with a single paper record.

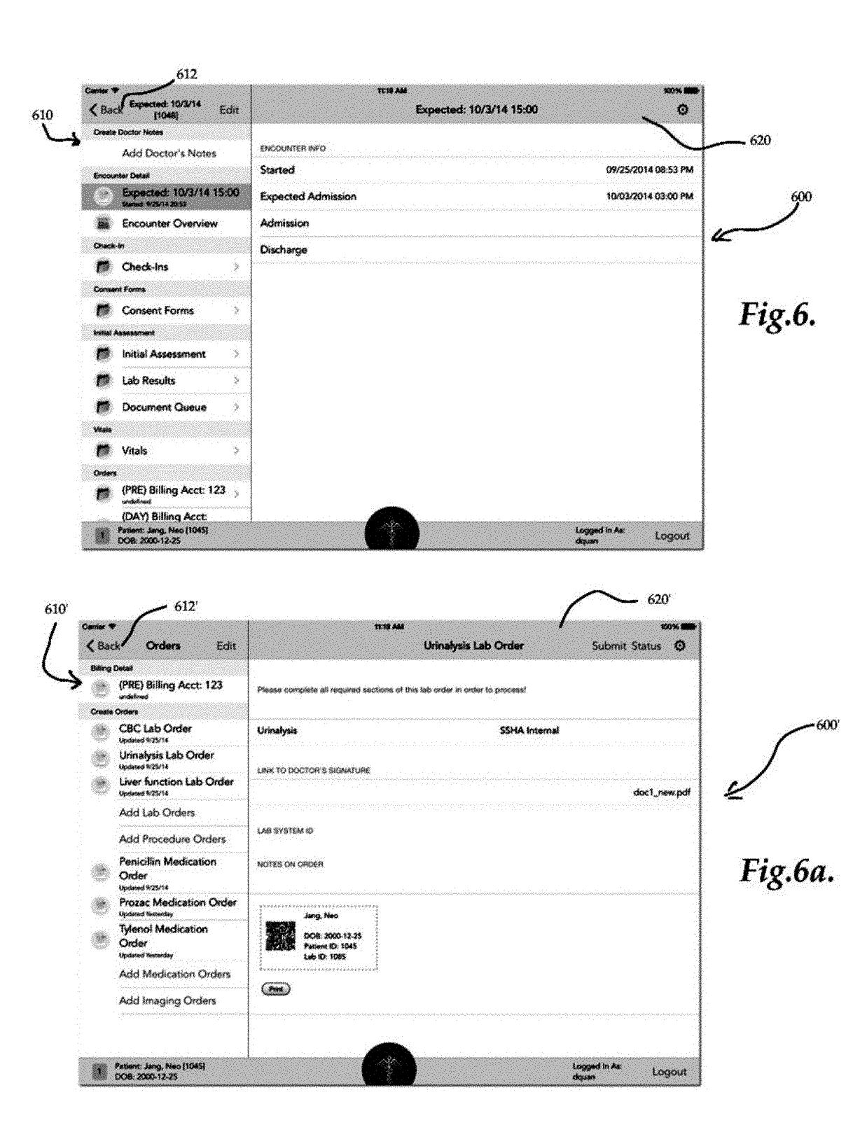

FIG. 6 illustrates an example of a TOC sub-level 600 accessed from the TOC 410 in FIG. 4. The TOC sub-level 600 may further display links for additional documents/forms which may be useful based on the originating TOC item in TOC 410, as illustrated with the further TOC sub-level items 610 and/or a selected item 620. A back button 612 may also be included to return the user to the higher TOC level. FIG. 6a may further display a TOC sub-level 600′ which may be accessed from the TOC sub-level 600 in FIG. 6 to display additional documents/forms, such as illustrated with additional further TOC sub-level items 610′ and/or a selected item 620′. Similarly, a back button 612′ may also be included to return the user to the higher TOC level. As discussed above, the TOC levels and/or sub-levels may generally display links to documents/forms without affecting the underlying storage of the documents.

In yet another aspect of the present invention, the system objects utilized by the EHR system of the present invention may generally be treated similarly to other institutional knowledge by an institution and may thus be backed up, versioned, updated in accordance with a defined change process, and/or otherwise treated in a similar manner to other institutional knowledge subject to management.

In some exemplary embodiments, system objects may generally define virtually every aspect of how users interact with the EHR system of the present invention at their institution. As such, the entire collection of system objects may be backed up, versioned, updated in accordance with a defined change process, etc. For example, at the beginning of an EHR system rollout, an initial version may be produced based on a combination of generic definitions for various items, such as, for example, tables of contents, patient forms, institution-specific customizations for patient admissions and/or lab processes. The next version and/or following versions of the system object collection may then be introduced in various ways to minimize disruption to the continuing operation of the EHR system at the institution. It may be desirable to perform updates on these system objects on a copy or instance of the EHR system of the present invention which may be dedicated to development and testing, and thus separate from the main operating instance being used by the institution. Thus, when the design work and/or other updating is complete and/or approved, the new collection of system objects may be copied to a training instance of the EHR system of the present invention, which may also be separate from the main operating instance, such as to allow the staff and/or other users to become familiar with the new changes without affecting the continuing operation of the main operating instance of the EHR system of the present invention at the institution. After adequate training, debugging and/or other finalization, the system object collection may then be pushed to production servers such that it may become part of mainstream use in the institution in the main operating instance of the EHR system of the present invention.

In some embodiments, the EHR system of the present invention may provide for managing versions of the system object collection by utilizing a synchronization tool which may facilitate transfer of system object definitions between instances of the EHR system of the present invention, such as, for example, between a development and testing instance, a training instance and the main operating instance. In one embodiment, the synchronization tool may utilize methods of identifying versions of system objects such that there may be minimal ambiguity when synchronizations occur. For example, the synchronization tool may identify different versions and give users the option of copying an updated version of a system object from one instance to another, such as, for example, on an individual basis, or for further example, en masse or as batches.

In other embodiments, the EHR system of the present invention may provide for managing versions of the system object collection by utilizing standard software development source control practices which may generally treat every system object as a source file that may be checked out and updated from a source control repository. For example, the EHR system of the present invention may utilize, for example, a git repository for the source files of the system objects. Source control may, for example, generally enable larger sets of personnel to work on updates at the same time and/or manage the changes that are introduced by each in a more systematic fashion. For further example, standard software development source control practices may also employ well-established best practices for backing up and maintaining repositories, such as git, that may be implemented to safeguard system objects utilized by an institution.

In some exemplary embodiments, the EHR system of the present invention may further include features for modifying and/or customizing system objects which may be accessible directly from the user interface on a device. This may be desirable as forms, templates, and/or other system object components of the EHR system of the present invention may be modified and/or customized on the fly instead of being wholly dependent on time-delayed development and/or customization. For example, customization may thus occur on-site and/or during the course of using the EHR system of the present invention rather than waiting for long development/update cycles to occur. In some embodiments, system objects may be created and/or edited using a subset of YAML syntax directly from within the user interface of the EHR system of the present invention.

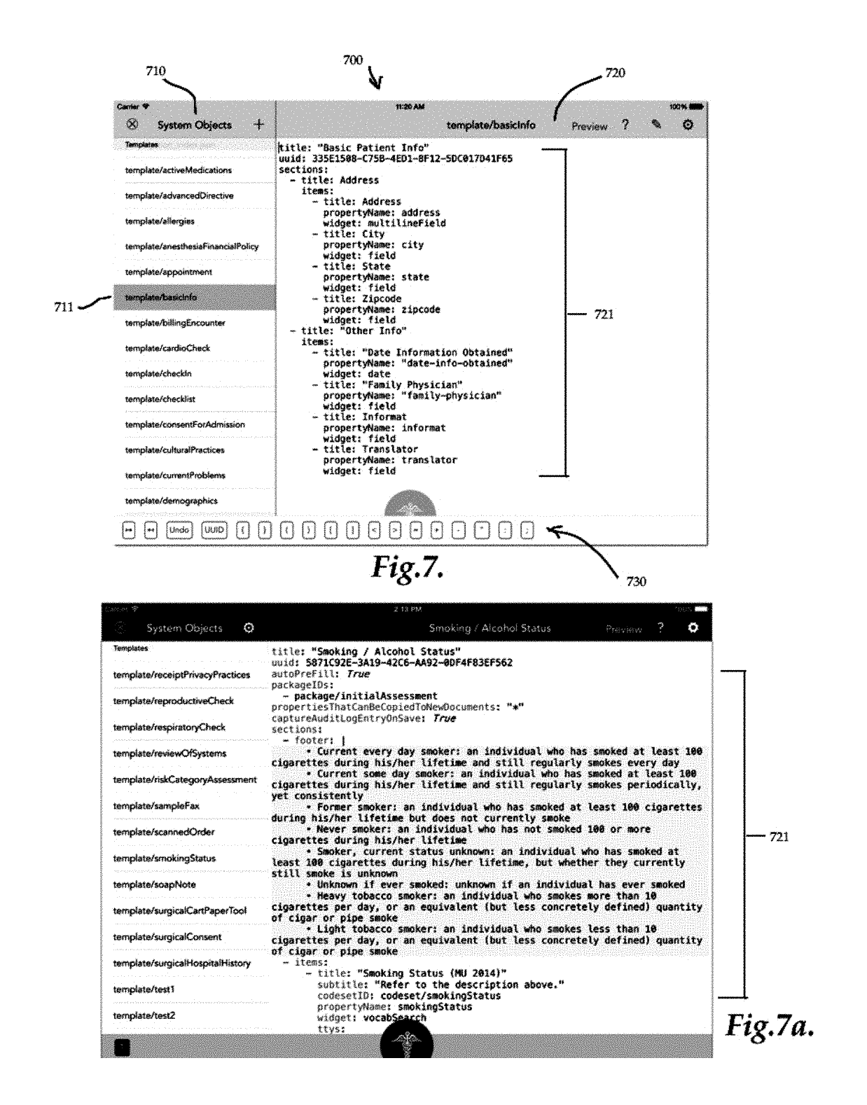

FIGS. 7 and 7a illustrate examples of a system object editor 700 accessible from the user interface of the EHR system of the present invention, which may include, for further example, a listing of existing system objects 710, which may be selected for editing, such as shown with selected system object 711 being displayed in the editing widget 720. A user may then edit the definition, such as with YAML syntax as illustrated with the system object definition 721, showing, for example, a definition for basic patient information template in FIG. 7 and a definition for a smoking/alcohol status template in FIG. 7a. Additional editing tools, such as specific syntax buttons 730 may also be provided.

In another aspect of the present invention, the EHR system of the present invention may utilize workflows to facilitate and/or conduct the review and/or approval of documents by a set of users.

In some embodiments, work queues may be utilized and may include a list of documents that have been posted for consumption, review and/or approval by a recipient, in a similar manner to an inbox of an email application. In general, the EHR system of the present invention may provide a work queue for each user and/or a single work queue for each group of users, as illustrated with the approval queue 160 in FIG. 1a. The EHR system user interface may further include a dashboard where users may view the lists of documents that have been posted to their own work queues and/or the work queues of any groups to which they belong.

FIG. 2 illustrates a work queue view 200 accessible from the work queue button 112. The work queue view 200 may generally display a listing 210 of items for review and/or approval by the user, and each individual item may be viewed by selecting, such as illustrated with the selected item 220. The selected item 220 may further include additional controls 222, such as a button to submit an order, view the status of the order in the workflow, and/or show additional options, as illustrated.

In general, posting a document to a work queue may not remove it from anywhere else in the EHR system of the present invention, such as, for example, from the patient record and/or other accessible location, but rather work queues may merely contain links to the documents that have been posted to them. For further example, when a document is removed from a work queue, in general only the link may be deleted from the queue while the underlying document is not affected or deleted. In this manner, the EHR system of the present invention may take advantage of an electronic system, such as with document check-in and check-out features, which may enable the EHR system f the present invention to preserve the underlying documents in a central storage while enabling them to be linked, visible and/or otherwise accessed from various parts of the EHR system of the present invention without creating conflicts.

In some embodiments, the documents in a work queue and/or workflow may require review and/or approval by certain users, such as, for example, before the documents may progress in the workflow. In one embodiment, the documents in the workflow may be signed by appropriate users to continue the workflow. In one embodiment, a document may be said to have completed its workflow if signatures are collected from all necessary users and/or parties. The list of necessary users and/or parties may be determined based on the workflow steps. FIG. 2 illustrates the display of a necessary signature 224 for an order in a workflow item 220.

In general, signatures may be digital signatures or manual signatures. A digital signature may be created, for example, by using a public/private key pair that may be generated for each user when he/she signs a form for the first time and may further be protected by a password or other encryption key, which may be utilized as the user's signing password. Digital signatures in the EHR system of the present invention may use, for example, a hash of the HSD, for example JSON property values visible to the user on the form, which may be desirable to enable auditors to confirm that the signature is authentic and/or that the signature corresponds to the data shown on the screen at the time of the signature.

A manual signature may also be utilized, and may essentially be a piece of human-readable evidence that may generally take the form of a traditional written signature, which may also be given a visual representation in the user interface of the EHR system of the present invention. Manual signatures may be stored, for example, in a property of the document that is declared to the workflow system using a property of the template for the document. Unlike a digital signature, a manual signature may generally not be authenticated by the EHR system per se and the EHR system may therefore, for example, require the user to attest that the manual signature has been captured properly on behalf of an authorized submitter as part of, for further example, auditability.

The submitter of a document in a workflow may generally be the user who initiates a particular workflow process; however, the submitter may not necessarily be the same as the person who submits the document at the end of a step in the workflow. For example, many institutions allow for telephone orders and/or orders received by fax or other paper-based means, and thus the person submitting a document may be acting on behalf of the actual submitter of the document, such as, for example, a physician, which in the case of an order may be the only type of user authorized to legally submit an order.

In some embodiments, submissions in a workflow may be restricted in the EHR system of the present invention such that only authorized and/or proper users may submit. For example, if a user does not belong to one of the specified user classes in the EHR system of the present invention, the EHR system may prompt the user to specify which user on whose behalf the form and/or other workflow item is being submitted. In this manner, for example, a user may enter a telephone, fax and/or other remote order, which may cause the EHR system of the present invention to start the workflow as if the authorized user had already signed and/or also in parallel (i.e., not obstructing the normal workflow) place the document into the queue of the authorized user to do a final signoff. In embodiments using a manual signature, the EHR system may create a digital signature based on, for example, the public/private key pair of the user that actually entering the submission, while also incorporating the identifying information of the user on whose behalf the submission is actually being made.

In general, the steps of a workflow may specify the order in which signatures and/or other authorizations are to be collected. A step may either specify a particular user and/or a group of users that indicates the kind of signature that may be needed to complete a step. For example, if a step specifies a particular user, the step is considered complete if the document has collected that user's signature. For further example, for a step specifying group of users, a signature from any user in that group may be sufficient. Thus, the EHR system of the present invention may examine the workflow steps sequentially to find the first step that has not been completed when submissions are made in the workflow. The particular user and/or group of users of that step may further determine the particular work queue into which the document is placed. Thus when all steps are completed, the document may be placed in the completed queue, such as may be defined by the template of the document.

Notes may also be incorporated into the various steps of the workflow, such as, for example, to enable users to annotate and/or comment as the workflow progresses. A notes widget may be included in a form by the template such that notes may be easily added from the user interface of the EHR system. As illustrated in FIG. 2, notes 226 may be displayed for the workflow item 220.

### Example of TOC Functionality

In one example, when a user first opens a patient record, a TOC level is presented on the left hand side of the EHR system. Every TOC level acts in fundamentally the same way: a TOC level is focused on a single document (in this case, the patient document) and displays a list of documents that result from a database query defined by the tocLevel document (queryExpression property). The UI for this list is broken down into sections that are defined by config documents. There may be multiple config documents and a subset of these will apply to the current situation because they contain a tocLevelID property that corresponds to the active TOC level and a list of groups under the targetGroupIDs property that can be matched against the current user's group membership. When a TOC level is loaded, the UI automatically queries for all matching config documents and composes the sections defined therein into a single list. The sections in the config documents (listed under the sections property) act to filter documents that were returned by the database query mentioned above.

### Example of Querying for Documents to Appear in a TOC Level

The tocLevel document may contain a queryExpression property whose string value is expected to be a JavaScript expression that, when evaluated, should yield a JSON object that is to be passed to “MongoDB” to perform a database query. Within this JavaScript expression, some commonly-used expressions include:

1) context.document refers to the document the TOC level is focused on

2) context.document._id refers to the ID of the document the TOC level is focused on

It is also common to structure the queryExpression as follows:

queryExpression:|
jsonExpression={ . . . }

The reason for starting the expression with jsonExpression=is to take advantage of the JSON syntax built into JavaScript for constructing the query object, which is only available for expressions on the right hand side of the assignment (=) operator.

When the user selects a document listed in a section under a TOC level, one of several actions can be defined to take place. If the document is set up to trigger a navigation to a deeper TOC level, the UI “pushes” the current TOC level onto the navigation stack and the new TOC level is displayed. (By “push” we are referring to the fact that a “Back” button appears to allow “popping” back to the old TOC level.) The focus document of this new TOC level will be determined by how the navigation trigger to the TOC level is set up. If the document is not set up to trigger a TOC level navigation, then it will be opened on the right hand pane.

The TOC level also allows users to create new documents. As with document selection, document creation can also be set up to not create a user-editable document on the right hand pane per se but instead to create a document whose main purpose is to act as a container for other documents and trigger navigation to a deeper TOC level. “Encounters” and “billing accounts” are examples of such container documents.

### Example of Defining Sections in a TOC

As mentioned above, sections are defined by the sections property of config documents. An individual section in the sections array has an items property that specifies the order of the menu items that appear under that section. Each item in the items array is assumed to be a document ID. The type of the corresponding document determines the behavior of the corresponding menu item(s) displayed:
1) An ID of a template document instructs the UI to display the documents created from that template.
2) An ID of a tocLevel document instructs the UI to display a reference to this TOC level which, when pressed, triggers navigation to that TOC level but with the same focus document as the current TOC level. This option is useful if the child TOC level is to display a subset of the documents from the current TOC level.
3) An ID of a report document instructs the UI to display a reference to this report which, when pressed, displays the report on the right hand pane with the same focus document as the current TOC level.

### Examples of Workflow:

In one aspect, an example of an example of work flow with just workflow steps in healthcare area may be a workflow for an X-ray order as follows:
1. a doctor fills in an X-ray order form
2. a doctor signs the X-ray order form (the need for the doctor's signature is defined in the workflow steps built into the X-ray order form layout)
3. the X-ray order is routed to the radiology technician queue to notify the technician to prepare to do the order needed for the patient (the final destination for the form radiology is defined in the workflow steps built into the X-ray order form layout).

In another aspect, an example of workflow with just a modal process in the healthcare area may be a workflow for registering a patient for a lab visit, as follows:
1. the check in desk attendant asks the patient for ID
2. the attendant locates the patient's record in the EHR based on last name and date of birth
3. the attendant taps a button on the mobile device to bring up a modal process that dynamically generates a form to confirm the patient's lab appointment details (time, specific kind of lab, etc.) and generates a barcode label bracelet to be printed.

In a further aspect, an example of workflow that includes both the modal process and workflow steps in the healthcare area may be a workflow for a prescription order, as follows:
1. a doctor fills in a medication order form
2. a doctor signs the medication order form (the need for the doctor's signature is defined in the workflow steps built into the medication order form layout)
3. the medication order is routed to the pharmacists' queue (the second approver—pharmacy—is defined in the workflow steps built into the medication order form layout)
4. the pharmacist uses a modal process specifically designed to show him/her the medication order alongside the patient's current medications and allergies on a form dynamically generated by the modal process
5. later on, the pharmacist uses a modal process specifically designed to dynamically generate a form showing upcoming doses that need to be dispensed (called the “fill list”), and he/she dispenses the medication dose that is needed
6. the nurse then takes that medication dose and uses another modal process specifically designed to show a form prompting the nurse to confirm the date, time, quantity, route, and drug substance and then to ask for the nurse's signature when the dose has been administered.

It will be appreciated by those of ordinary skill in the art that the present invention can be embodied in other specific forms without departing from the spirit or essential character hereof. The present description is therefore considered in all respects to be illustrative and not restrictive. The scope of the present invention is indicated by the appended claims, and all changes that come within the meaning and range of equivalents thereof are intended to be embraced therein.

1. A method for implementing and customizing an electronic health record (EHR) system at a healthcare institution comprising:
providing a server component of an EHR system to an institution on at least one server, said EHR system including software for configuring said at least one server to interface with a plurality of user access devices hosting a client component of said EHR system and including underlying data handling features for handling of information being capable of creating, adding information to and retrieving information from hierarchically-structured data (HSD) documents stored on a storage device in a set of separate of files from said software;
creating a series of system object HSD documents which define a plurality of system objects, said system objects defining the manner that information is displayed to and gathered from users on said client component of said EHR system and further defining the data structure of said information to be inserted into HSD documents for saving and storage; and
customizing said EHR system on said at least one server by customizing the input and output configuration of said system objects by modifying at least one of said system object HSD documents to create customized system objects which conform with the institutional practices of said institution, wherein said customizing does not alter said software or other HSD documents;
wherein said customizing creates a production version of said EHR system for active use.

2. The method of claim 1, wherein said at least one server comprises a testing server and a production server, said testing server storing and running said EHR system during said customizing and being adapted to push said production version of said EHR system to said production server for active use.

3. The method of claim 1, further comprising training said users on operating said system objects after said customizing of said EHR system by utilizing said client component of said EHR system interfaced with said at least one server.

4. The method of claim 1, wherein said EHR system stores and retrieves healthcare information by creating, accessing or modifying said HSD documents and does not modify said system object HSD documents or said software.

5. The method of claim 1, further comprising creating a customized user interface by defining a set of said system object HSD documents, said system object HSD documents being utilized by said plurality of user access devices to generate a graphical user interface for displaying and gathering healthcare information.

6-41. (canceled)

42. A method for implementing and customizing an electronic record management (ERM) system at an institution comprising:
providing a server version of an ERM system to an institution on at least one server, said ERM system including software for configuring said at least one server to interface with a plurality of user access devices hosting a client version of said ERM system and including underlying data handling features for handling of information being capable of creating, adding information to and retrieving information from hierarchically-structured data (HSD) documents stored on a storage device as separate files from said software;
creating a series of system object HSD documents which define a plurality of system objects, said system objects defining the manner that institutional information is displayed to and gathered from users on said client version of said ERM system and further defining the data structure of said institutional information to be inserted into HSD documents for saving and storage; and
customizing said ERM system on said at least one server by customizing the input and output configuration of said system objects by modifying at least one of said system object HSD documents to create customized system objects which conform with the institutional practices of said institution, wherein said customizing does not alter said software or other HSD documents;
wherein said customizing creates a production version of said ERM system for active use.

43. (canceled)

44. The method of claim 42, wherein said institutional information is selected from the group consisting of electronic healthcare information, human resource management information, accounting information, project management information, customer relationship information and campaign management information.
